(19) United States
(12) Patent Application Publication
(10) Pub. No.: US 2013/0117095 A1
(43) Pub. Date: May 9, 2013

(54) METHOD FOR PROVIDING OFFER GROUPS TO CURATE PROMOTIONAL OFFERS

(71) Applicants: Mark Hunter Madsen, Vancouver (CA); June Oakes, Glen Mills, PA (US); William Nicholas Weir, Phoenixville, PA (US)

(72) Inventors: Mark Hunter Madsen, Vancouver (CA); June Oakes, Glen Mills, PA (US); William Nicholas Weir, Phoenixville, PA (US)

(73) Assignee: ChoozOn Coporation, King of Prussia, PA (US)

(21) Appl. No.: 13/292,078

(22) Filed: Nov. 8, 2011

(51) Int. Cl. G06Q 30/02

(52) U.S. Cl. 705/14.36; 705/14.39

(57) ABSTRACT

An improved system and method of providing offer groups to curate an offer list of promotional offers from multiple offer sources in an online service is provided. Components for offer groups support operations accessible through a graphical use interface for creating, editing, joining, and searching for offer groups, as well as curating and viewing offers of offer groups. Such operations may be governed according to rules of membership of an offer group, roles of members of an offer group, rules of visibility of an offer group, and rules of curating promotional offers for the list of promotional offers of the offer group. A user may create an offer group which others may join to participate in curating offers of interest to the group. Or users may identify and join offer groups of interest to browse curated lists of promotional offers pertaining to those interests.

### CROSS-REFERENCE TO RELATED APPLICATIONS

The present invention is related to the following United States patent application, filed concurrently herewith and incorporated herein in its entirety:

“System for Providing Offer Groups to Curate Promotional Offers,” Attorney Docket No. 0010; and

“Method Using a Graphical User Interface to Perform Operations on Offer Groups to Curate Promotional Offers,” Attorney Docket No. 0012.

### FIELD OF THE INVENTION

The invention relates generally to computer systems, and more particularly to an improved system and method of providing offer groups to curate an offer list of promotional offers from multiple offer sources provided by an online service.

### BACKGROUND OF THE INVENTION

In the emerging web-based deal economy today, merchants representing thousands of different products work with affiliate networks of online publishers that post their offers across hundreds or thousands of locations on the Web. These merchants operate an infrastructure or engage specialized networks such as Commission Junction, LinkShare, or the Google Affiliate Network that provide services which carefully track actions by online users on online publisher websites, such as impressions viewed, click-throughs and purchases, and typically compensate by commissions the publishers who drive leads and sales.

A number of online publisher websites have become aggregators of deals and coupons, such as Coupon Mountain and Coupon Cabin. These online publishers focus on aggregating the largest number of offers from the largest number of brands possible, and some have built coupon directories representing thousands of coupons. To increase the number of deals published on their websites, some aggregators such as RetailMeNot and SlickDeals invite the public to post deals on their websites that were found elsewhere. Although such websites attract a large online audience, consumers are easily overwhelmed by the number of deals on these websites and often suffer a tedious and daunting user experience from searching through the giant inventory in these website directories to find relevant deals and coupons. As a result, many consumers experience deal fatigue from browsing such websites and abandon their search without finding relevant deals or coupons.

On the other end of the spectrum, some online publisher websites feature one or relatively few daily deals. In particular, group discount buying was introduced by Living Social, popularized by Groupon, and quickly emulated by hundreds of such websites offering deals in every major American city. Such websites send one deal per day that is price-discounted by 50% to 80% if group buying minimums are met. Whereas online publisher websites of giant coupon directories may overwhelm consumers with excessive choices, deal-of-the-day websites may feature a rather narrow range of high-margin, low-cost services from local businesses that may not always be relevant to a consumer. Moreover, consumers are now becoming overwhelmed by the recent proliferation of local daily deals and group discount offers.

Whether browsing on coupon warehouse websites, daily deal websites or group discount offer websites, consumers find it too difficult to discover relevant deals online and become frustrated by surfing multiple sites in search of relevant deals. What is needed is a system and method for an online user to discover relevant offers without experiencing deal fatigue. Such a system and method should allow users to find offers for products they want and brands they like.

### SUMMARY OF THE INVENTION

Briefly, the present invention may provide a system and method of providing offer groups that curate an offer list of promotional offers from multiple offer sources provided by an online service. In various embodiments, a client computer or mobile computing device may be operably connected to an offer server. The client computer or mobile computing device may include an offer application operably coupled to a an offer application user interface having functionality for visualization and navigation of a graphical user interface for requesting and displaying information about offer groups, and more particularly, for receiving input from a user interacting through the graphical user interface to request performance of an operation for an offer group and functionality for displaying results received from the server after performing the requested operation for the offer group.

The offer application user interface may be operably coupled to an offer group user interface and a personalized offer group user interface. The offer group user interface provides components with functionality for a user interacting with user interface elements of a graphical user interface to create, edit, join, and search offer groups, as well as curate and view offers of offer groups. The personalized offer group user interface provides components with functionality for a user interacting with user interface elements of a graphical user interface to navigate among a list of the user's offer groups and display promotional offers from the user's offer groups. In particular, an offer group membership component includes functionality for viewing membership, accepting and rejecting membership, and changing roles. An offer group offer submission component includes functionality for submitting, approving and rejecting offers according to the rules of offer approval. And a find offer groups component includes functionality for discovering offer groups visible to a user.

In response to receiving a request to perform an operation for an offer group, an offer server with support services for providing promotional offers, offer lists, and offer groups, may process requests to perform operations on offer groups. The offer server may include a consumer offer application with functionality to provide offer groups that curate an offer list of promotional offers from multiple offer sources. The consumer offer application may include a brand component that manages brand information for brands, a product type component that manages product type information for product types, an offer component that manages offer information for offers, an offer list component that manages offer list information for offer lists, an offer group component that manages information for offer groups, and a consumer application programming interface (API) that may be invoked to perform operations provided by the consumer application component. The consumer application programming interface may include an offer group application programming interface (API) that may be invoked to perform operations for offer groups that curate an offer list of promotional offers from multiple sources.

Moreover, the present invention may provide operations for offer groups that curate an offer list of promotional offers from multiple offer sources provided by an online service. Such operations include creating an offer group, finding offer groups, joining an offer group, and submitting suggested offers for curator approval. An operation to create an offer group may be supported by functionality for assignment of attributes of an offer group, assignment of rules of membership of an offer group, assignment of roles of members of an offer group, assignment of rules of visibility of an offer group, and assignment of rules of curating promotional offers for the list of promotional offers of the offer group. An operation to find offer groups may be supported by functionality for recommendation of offer groups and offers within recommended offer groups, functionality for discovery of most popular offer groups and offers within the most popular offer groups, and functionality for listing new offer groups and offers within the new offer groups, according to the rules of visibility of offer groups. An operation to join an offer group may be supported by functionality for submission of membership requests by a nonmember and by functionality for approval or rejection of membership requests according to rules of membership of an offer group. And an operation for submitting suggested offers for approval may be supported by functionality for submission of suggested offers by a member and by functionality for approval or rejection of submissions of suggested offers for approval according to rules of curating promotional offers for the list of promotional offers of the offer group.

Advantageously, the present invention may flexibly allow curating a list of offers pertaining to an offer group by a curator or a group. Any user who has an interest may create a group which others may join to participate in curating offers of interest to the group. Or users may identify and join offer groups of interest, and then browse lists pertaining to those interests procured by others who share those same interests. Conveniently, users of an offer group may receive notifications of updates to the list of offers of the offer group.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components to provide offer groups that curate an offer list of promotional offers from multiple offer sources, in accordance with an aspect of the present invention;

FIG. 3 is a block diagram generally representing an exemplary architecture of system components of the offer application user interface in an embodiment for providing offer groups that curate an offer list of promotional offers from multiple offer sources, in accordance with an aspect of the present invention;

FIG. 4 is a flowchart generally representing the steps undertaken for creating an offer group with members that share access to a list of promotional offers selected by a curator from a plurality of offer sources in one embodiment, in accordance with an aspect of the present invention;

FIG. 5 is a flowchart generally representing the steps undertaken in one embodiment with a graphical user interface for creating an offer group with members that share access to a list of promotional offers selected from a plurality of offer sources by a curator, in accordance with an aspect of the present invention;

FIG. 6 is an exemplary illustration generally representing a screen of a graphical user interface for displaying information about offer groups in an online service, in accordance with an aspect of the present invention;

FIG. 7 is an exemplary illustration generally representing a screen of a graphical user interface in one embodiment for creating an offer group, in accordance with an aspect of the present invention;

FIG. 8 is an exemplary illustration generally representing a screen of a graphical user interface in various embodiments for assigning attributes, the rules of curating offers, the rules of membership, the rules of visibility and the roles of the users for the creation of a new offer group, in accordance with an aspect of the present invention;

FIG. 9 is a flowchart generally representing the steps undertaken in one embodiment for assigning attributes to an offer group with members that share access to a list of promotional offers selected from a plurality of offer sources by a curator, in accordance with an aspect of the present invention;

FIG. 10 is a flowchart generally representing the steps undertaken in one embodiment for assigning rules of curating offers to an offer group with members that share access to a list of promotional offers selected from a plurality of offer sources, in accordance with an aspect of the present invention;

FIG. 11 is a flowchart generally representing the steps undertaken in one embodiment for assigning rules of membership to an offer group with members that share access to a list of promotional offers selected from a plurality of offer sources, in accordance with an aspect of the present invention;

FIG. 12 is a flowchart generally representing the steps undertaken in one embodiment for assigning rules of visibility to an offer group with members that share access to a list of promotional offers selected from a plurality of offer sources, in accordance with an aspect of the present invention;

FIG. 13 is a flowchart generally representing the steps undertaken in one embodiment for assigning roles of users of an offer group with members that share access to a list of promotional offers selected from a plurality of offer sources, in accordance with an aspect of the present invention;

FIG. 14 is an exemplary illustration generally representing a screen of a graphical user interface in various embodiments for viewing membership and assigning roles of the users of an offer group, in accordance with an aspect of the present invention;

FIG. 15 is a flowchart generally representing the steps undertaken in one embodiment for finding and displaying information about offer groups in an online service, in accordance with an aspect of the present invention;

FIG. 16 is a flowchart generally representing the steps undertaken in one embodiment for a user in an online service to join an offer group, in accordance with an aspect of the present invention;

FIG. 17 is a flowchart generally representing the steps undertaken in one embodiment for a curator of an offer group to process a request for a nonmember to join an offer group, in accordance with an aspect of the present invention;

FIG. 18 is a flowchart generally representing the steps undertaken in one embodiment for a member of an offer group to unjoin the offer group, in accordance with an aspect of the present invention;

FIG. 19 is an exemplary illustration generally representing a screen of a graphical user interface in various embodiments for viewing an offer group and displaying a user interface control selectable to unjoin the offer group, in accordance with an aspect of the present invention;

FIG. 20 is a flowchart generally representing the steps undertaken in one embodiment to process a request for a member of an offer group to unjoin the offer group, in accordance with an aspect of the present invention;

FIG. 21 is an exemplary illustration generally representing a screen of a graphical user interface for displaying new messages for a curator of an offer group in an online service, in accordance with an aspect of the present invention;

FIG. 22 is an exemplary illustration generally representing a screen of a graphical user interface for displaying an offer group to a curator of the offer group, in accordance with an aspect of the present invention;

FIG. 23 is an exemplary illustration generally representing a window of a graphical user interface with user input controls to accept or reject a membership application request, in accordance with an aspect of the present invention;

FIG. 24 is an exemplary illustration generally representing a window of a graphical user interface for rejecting a membership application request, in accordance with an aspect of the present invention;

FIG. 25 is an exemplary illustration generally representing a window of a graphical user interface for sharing an offer, including submitting a request for approval of a suggested offer to be added to the list of promotional offers of the offer group, in accordance with an aspect of the present invention;

FIG. 26 is a flowchart generally representing the steps undertaken in one embodiment for a user in an online service to join an offer group, in accordance with an aspect of the present invention;

FIG. 27 is an exemplary illustration generally representing a window of a graphical user interface for approving a suggested offer to be added to a list of promotional offers of an offer group, in accordance with an aspect of the present invention;

FIG. 28 is an exemplary illustration generally representing a window of a graphical user interface for sending a message of rejection of an offer approval request for a suggested offer, in accordance with an aspect of the present invention;

FIG. 29 is a flowchart generally representing the steps undertaken in one embodiment for a member of an offer group to request approval for a suggested offer to be added to the list of promotional offers of the offer group, in accordance with an aspect of the present invention;

FIG. 30 is a flowchart generally representing the steps undertaken in one embodiment for a curator of an offer group to approve a request to add a suggested offer to the list of promotional offers of the offer group, in accordance with an aspect of the present invention;

FIG. 31 is an exemplary illustration generally representing a window of a graphical user interface for commenting on an offer in a list of promotional offers of an offer group, in accordance with an aspect of the present invention;

FIG. 32 is a flowchart generally representing the steps undertaken in one embodiment for commenting on an offer in a list of promotional offers of an offer group, in accordance with an aspect of the present invention;

FIG. 33 is an exemplary illustration generally representing a screen of a graphical user interface in various embodiments for editing the attributes, the rules of curating offers, the rules of membership, the rules of visibility and the roles of the members of an offer group, in accordance with an aspect of the present invention;

FIG. 34 is an exemplary illustration generally representing a screen of a graphical user interface in various embodiments for viewing membership and assigning roles of the users of an offer group, in accordance with an aspect of the present invention;

FIG. 35 is a flowchart generally representing the steps undertaken in one embodiment on a client device for deleting an offer group in an online offer service, in accordance with an aspect of the present invention; and

FIG. 36 is a flowchart generally representing the steps undertaken in one embodiment on a server for deleting an offer group in an online offer service, in accordance with an aspect of the present invention.

### DETAILED DESCRIPTION

### Exemplary Operating Environment

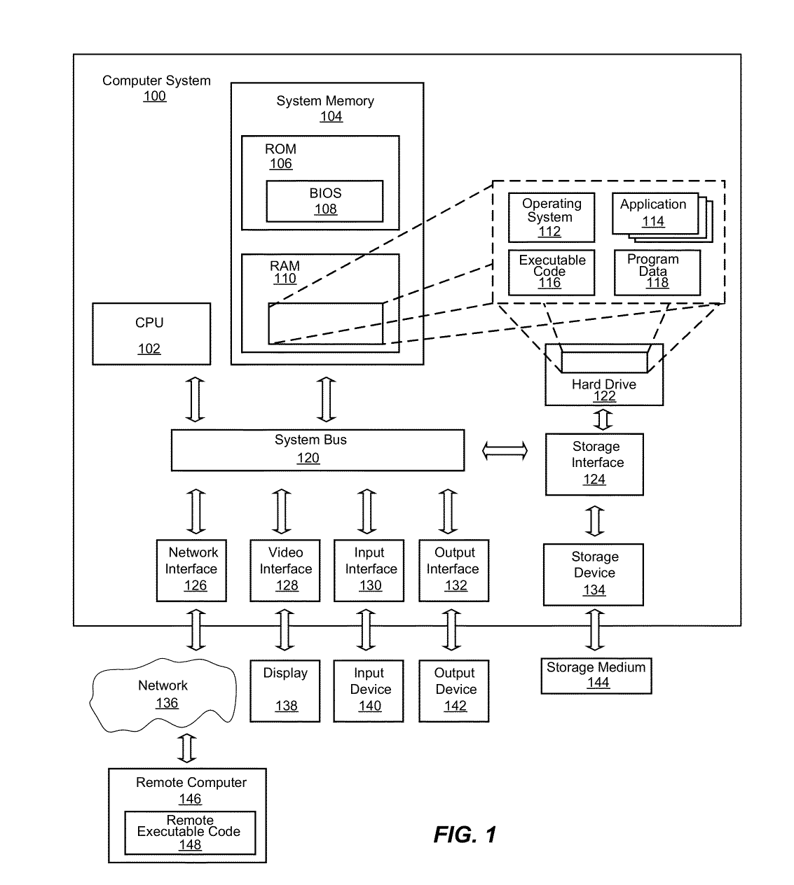

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, flash drives, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

### Providing Offer Groups to Curate Promotional Offers

The present invention is generally directed towards a system and method of providing offer groups that curate an offer list of promotional offers from multiple offer sources provided by an online service. More particularly, the present invention provides services that allow a user to create and manage an offer group which curates a list of promotional offers from multiple offer sources, such as brands, product types, shopping pals, offer lists, etc. An offer group as used herein means an object that includes a group of users, an offer list curated by one or more of the group of users, rules for membership to the group of users, rules for curating the offer list by one or more of the group of users, rules for visibility of the offer group, and may also include defined roles for the group of users. As used herein, a curator means a user responsible for administration of the offer group.

As will be seen, the invention may flexibly allow curating a list of offers pertaining to an offer group by a curator or a group. Any user who has an interest may create a group which others may join to participate in curating offers of interest to the group. Or users may identify and join offer groups of interest, and then browse lists pertaining to those interests procured by others who share those same interests. As used herein, an offer or promotional offer means any online promotion for goods or services, including without limitation coupons, vouchers, advertisements, and so forth. An offer list is a list of multiple offers, and, in an embodiment, may also include one or more offer lists. As will be understood, the various block diagrams, flow charts and scenarios described herein are only examples, and there are many other scenarios to which the present invention will apply.

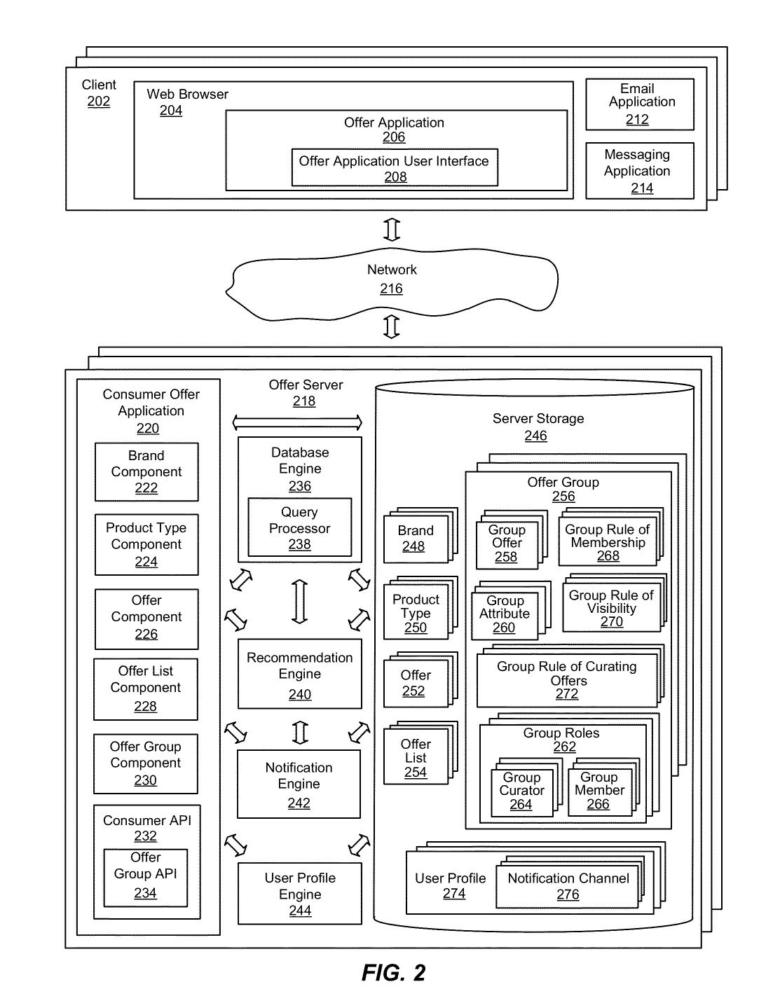

Turning to FIG. 2 of the drawings, there is shown a block diagram generally representing an exemplary architecture of system components to provide offer groups that curate an offer list of promotional offers from multiple offer sources. Those skilled in the art will appreciate that the functionality implemented within the blocks illustrated in the diagram may be implemented as separate components or the functionality of several or all of the blocks may be implemented within a single component. For example, the functionality for the offer application 206 on the client 202 may be implemented as a separate component from the web browser 204, which may be the case for a mobile device such as a smartphone. Note that in an embodiment on a mobile device, the functionality of the offer application 206 may be implemented both within the web browser 204 as shown and as a separate component so that a mobile device user may use either the web browser 204 with the functionality of the offer application 206 included or the offer application 206 as a separate application component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality of the present invention may also be implemented using a thin client whereby the functionality of the web browser 204, the offer application 206, the email application 212, and the messaging application 214 may be implemented on the server 218. In such an embodiment, the client 202 merely acts as an interface for a user to interact with the server 218.

In various embodiments, a client 202 may communicate with one or more servers 218 through a network 216. The client 202 may be a computer such as computer system 100 of FIG. 1 or another computing device including a mobile device such as a mobile phone. The network 216 may be any type of network such as a local area network (LAN), a wide area network (WAN), or other type of network. A web browser 204 may execute on the client 202 and may include functionality for receiving a request to perform an operation which may be input by a user and functionality for sending the request to a server to perform the operation. The web browser 204 may be operably coupled to an offer application 206 having functionality for receiving requests to perform an operation for an offer group and functionality for sending the requests to the server 218 to perform the requested operation for the offer group. The offer application 206 may be operably coupled to an offer application user interface 208 having functionality for visualization and navigation of a graphical user interface for requesting and displaying information about offer groups, and more particularly, for receiving input from a user interacting through the graphical user interface to request performance of an operation for an offer group and functionality for displaying results received from the server 218 after performing the requested operation for the offer group.

Other applications may also execute on the client 202 in various embodiments. For example, in embodiments where the client 202 may be a computing device such as a mobile phone, an offer application 206 operably coupled with an offer application user interface 208 may execute on the mobile phone. The offer application 206 in this embodiment may have functionality for receiving requests to perform an operation for an offer group and functionality for sending the requests to the server 218 to perform the requested operation for the offer group. The offer application user interface 208 in this embodiment may have functionality for visualization and navigation of a graphical user interface for requesting and displaying information about offer groups, and more particularly, for receiving input from a user interacting through the graphical user interface to request performance of an operation for an offer group and functionality for displaying results received from the server 218 after performing the requested operation for the offer group.

Moreover, additional applications may execute on the client 202 that enable notification of updates of a list of group offers in various embodiments through multiple notification channels for members and curators of an offer group. For instance, an email application 212 may function both as an instant or periodic notification channel to receive updates about group offers and may also function as a communication channel for a user to request performance of an operation for an offer group. Those skilled in the art may recognize that email messages may function as commands to the server 218 to perform any functions supported by the server 218. Finally, the messaging application 214 may also serve as an instant or periodic notification channel to receive updates about group offers and may also function as a communication channel for a user to request performance of an operation for an offer group. The messaging application 214 may be any type of messaging application including an instant messaging application, a text messaging application such as Simple Message Service (SMS), a chat messaging application, and so forth.

In general, the web browser 204, the offer application 206, the offer application user interface 208, the query interface 210, the email application 212, and the messaging application 214 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The server 218 may be any type of computer system or computing device such as computer system 100 of FIG. 1. In general, the server 218 may support services for providing promotional offers, offer lists, offer groups and for processing requests to perform operations on offer groups. In particular, the server 218 may include a consumer offer application 220 which includes functionality to provide offer groups to curate an offer list of promotional offers from multiple offer sources. The consumer offer application 220 may include a brand component 222 that manages brand information for brands, a product type component 224 that manages product type information for product types, an offer component 226 that manages offer information for offers, an offer list component 228 that manages offer list information for offer lists, an offer group component 230 that manages information for offer groups, and a consumer application programming interface (API) 232 that may be invoked to perform operations provided by the consumer application component 220 including operations performed by the brand component 222 for brands, operations performed by the product type component 224 for product types, operations performed by the offer component 226 for offers, and operations performed by the offer list component 228 for offer lists. The consumer API 232 may include an offer group application programming interface (API) 234 that may be invoked to perform operations, including operations performed by the offer group component 230, for offer groups that curate an offer list of promotional offers from multiple sources.

The consumer offer application 220 may be operably coupled to a database engine 236, a recommendation engine 240, a notification engine 242 and a user profile engine 244. The database engine 236 may provide database services and may include a query processor 238 having functionality to process received queries by retrieving the data from the server storage 246 and processing the retrieved data. The recommendation engine 240 may also be operably coupled to the database engine 236 and the notification engine 242. The recommendation engine 240 may provide recommendation services for the various operations of the consumer offer application 220 and may have functionality for receiving requests for recommendations for an operation of the consumer offer application 220, retrieving and ranking results, and returning a list of recommendations for the requested operation of the consumer offer application 220. The notification engine 242 may have functionality for receiving updates to offers, offer groups, offer lists, and other information for which a user may request notification, and the notification engine 242 may have functionality for sending notification of such updates in various embodiments through multiple notification channels including email application 212 and messaging application 214. The server 218 may additionally include a user profile engine 244 that manages user profile information including notification channels assigned to a user.

The consumer offer application 220, each of its components, the database engine 236, the recommendation engine 240, the notification engine 242 and user profile engine 244 may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The server 218 may additionally include server storage 246. The consumer offer application 220, database engine 236, the recommendation engine 240, the notification engine 242, and the user profile engine 244 may be operably coupled to server storage 246 that stores information for brands 248, information for product types 250, information for offers 252, information for offer lists 254, information for offer groups 256, and information for user profiles 274 including information of notification channels 276. The information saved in the server storage 246 for offer groups 256 may further include information for group offers 258, information for group attributes 260, information for group roles 262 including group curators 264 and group members 266, group rules of membership 268, group rules of visibility 270, and group rules of curating offers 272.

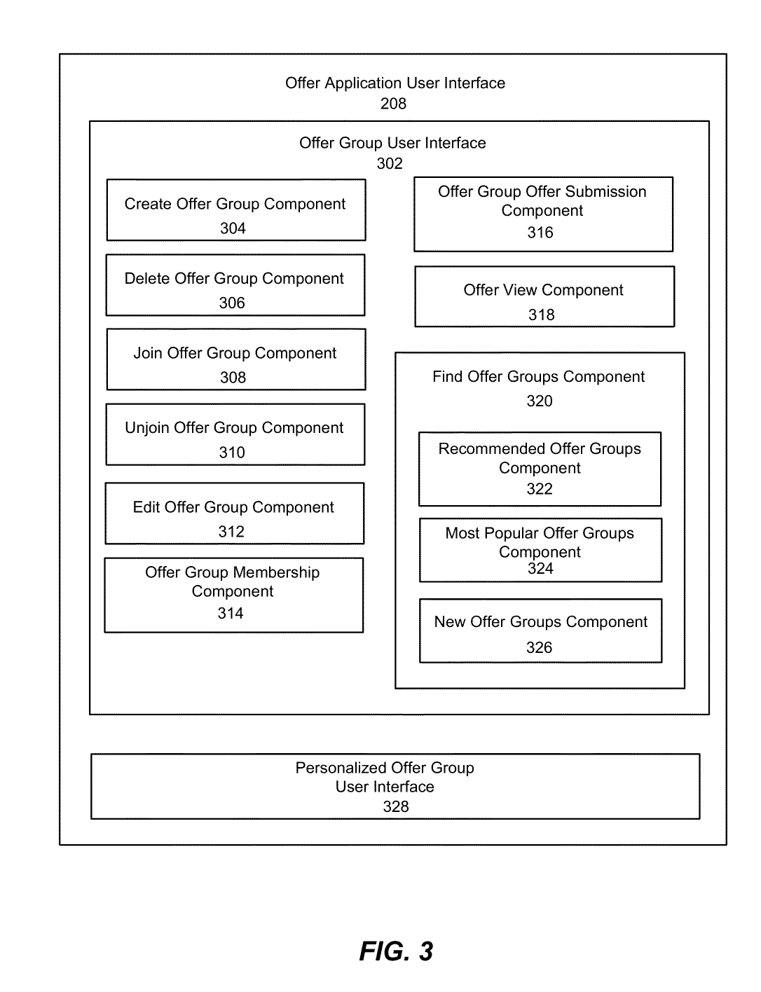

FIG. 3 presents a block diagram generally representing an exemplary architecture of system components of the offer application user interface 208. Those skilled in the art will appreciate that the functionality implemented within the blocks illustrated in the diagram may be implemented as separate components or the functionality of several or all of the blocks may be implemented within a single component. For example, the functionality for the recommended offer groups component 322 may be implemented as a separate component from the find offer groups component 320. Or the functionality of the recommended offer group component 322 may be included in the same component as the find offer group component 320 as shown. Moreover, those skilled in the art will appreciate that the functionality implemented within the blocks illustrated in the diagram may be executed on a single computer or distributed across a plurality of computers for execution.

In various embodiments, the offer application user interface 208 may be operably coupled to an offer group user interface 302 and a personalized offer group user interface 328. In general, the offer group user interface 302 provides functionality for a user interacting with user interface elements of a graphical user interface to create, edit, join, manage the membership of, and search offer groups, as well as curate and view offers of offer groups. As used herein, an element in a graphical user interface means any graphical user interface object such as a window, including without limitation, an application window, a dialog box, a message box, a toolbar, a control, a button, a menu, and so forth. In addition to a graphical user interface object such as a window, an element may also include a pane or frame of a window. The personalized offer group user interface 328 provides functionality for a user interacting with user interface elements of a graphical user interface to navigate among a list of the user's offer groups and display promotional offers from the user's offer groups. The offer group user interface 302 may include a create offer group create component 304 for creating an offer group, a delete offer group component 306 for deleting an offer group, a join offer group component 308 for joining an offer group, an unjoin offer group component 310 for unjoining an offer group, an edit offer group component 312 for editing attributes, rules and roles an offer group, an offer group membership component 314 for viewing membership, accepting and rejecting membership, and changing roles, and an offer group offer submission component 316 for submitting, approving and rejecting offers according to the rules of offer approval, and offer view component 318 for generating the presentation of promotional offers displayed within a screen of a graphical user interface to view offers of an offer group, and a find offer groups component 320 for discovering offer groups visible to a user. The find offer groups component 320 may include a recommended offer groups component 322 that provides functionality for a user interacting with user interface elements of a graphical user interface to display a list of recommended offer groups and offers within the recommended offer groups, a most popular offer groups component 324 that provides functionality for a user interacting with user interface elements of a graphical user interface to display a list of most popular offer groups and offers within the most popular offer groups, and a new offer groups component 326 that provides functionality for a user interacting with user interface elements of a graphical user interface to display a list of new offer groups and offers within the new offer groups. For each of the offer groups displayed in the list of recommended offer groups, most popular offer groups and new offer groups, the attributes of the offer group may also be displayed, including the list of curators associated with the offer group.

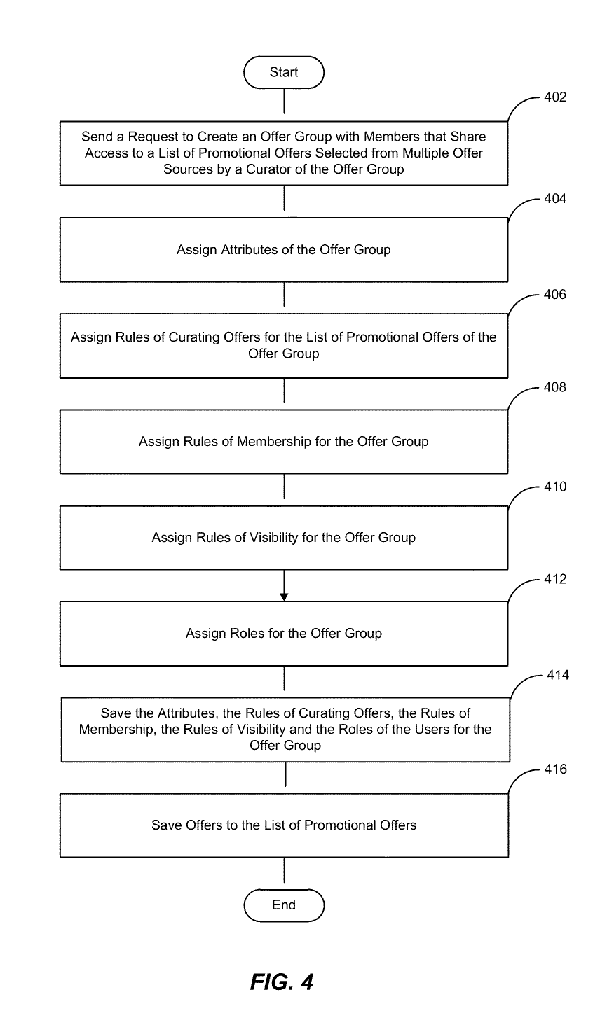

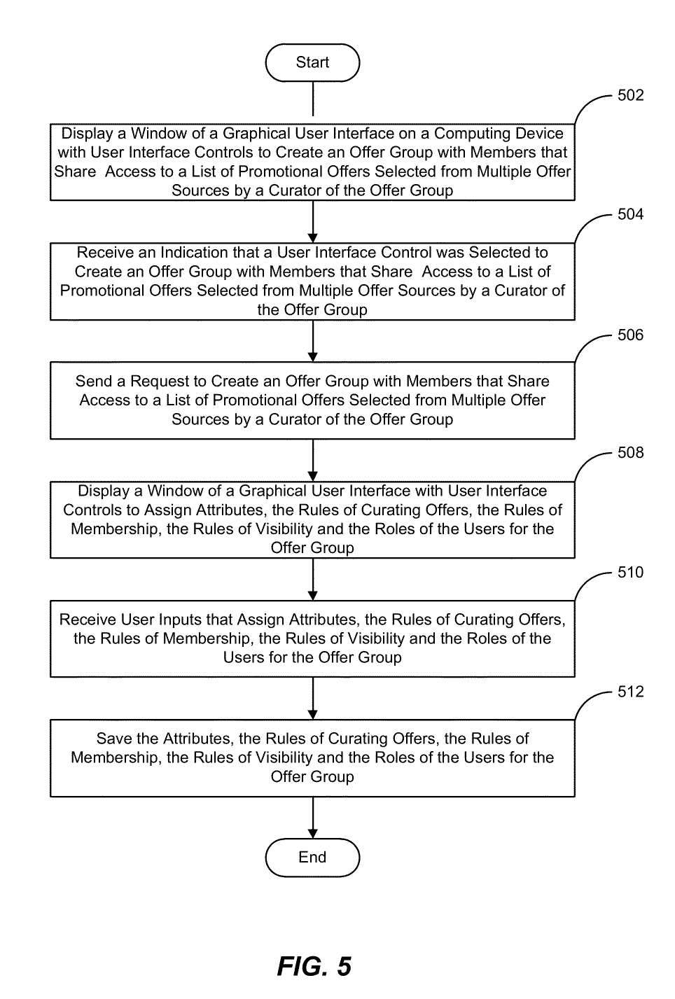

FIG. 4 presents a flowchart generally representing the steps undertaken in one embodiment for creating an offer group with members that share access to a list of promotional offers selected from a plurality of offer sources by a curator. At step 402, a request may be sent to create an offer group with members that share access to a list of promotional offers selected from multiple offer sources by a curator of the offer group. In an embodiment, a request may be sent by a client device to an offer server to create the offer group. At step 404, attributes of the offer group may be assigned. In an embodiment, attributes of the offer group may be assigned by receiving a plurality of user inputs to a graphical user interface as described below in further detail in conjunction with FIGS. 5-9. At step 406, rules of curating promotional offers for the list of promotional offers of the offer group may be assigned. In an embodiment, rules of curating promotional offers for the list of promotional offers of the offer group may be assigned as described below in further detail in conjunction with FIGS. 5-10.

At step 408, rules of membership for the offer group may be assigned. A rule of membership for the offer group may, for instance, specify whether a user of an online service may require acceptance by a curator of the offer group to become a member of the offer group. In an embodiment, rules of membership for the offer group may be assigned as described below in further detail in conjunction with FIGS. 5-10. At step 410, rules of visibility of the offer group may be assigned. A rule of visibility of the offer group may, for instance, specify for which users of an online service information about the offer group may be displayed when users of the online service search or browse for offer groups. In an embodiment, rules of visibility for the offer group may be assigned as described below in further detail in conjunction with FIGS. 5-10.

At step 412, roles may be assigned to the group of users of the offer group. There may be different roles a user may be assigned including a curator or a member. In general, a curator may be responsible for administration of the offer group, including assigning attributes, rules and roles. In an embodiment, roles for users of the offer group may be assigned as described below in further detail in conjunction with FIGS. 5-10.

At step 414, the attributes, the group rules of curating offers, the group rules of membership, the group rules of visibility and the group roles of the users for the offer group may be saved. In an embodiment, the attributes may be saved in a database storing records of attributes such as group attributes 260 of FIG. 2, the group rules of curating offers may be saved in a database storing rules of curating offers such as group rules of curating offers 272 of FIG. 2, the group rules of membership may be saved in a database storing rules of membership such as group rules of membership 268 of FIG. 2, the group rules of visibility may be saved in a database storing rules of visibility such as group rules of visibility 270 of FIG. 2 and the group roles of the users for the offer group may be saved in a database storing group roles of the users such as group roles 262 of FIG. 2. And at step 416, offers may be saved to the list of promotional offers. For instance, the curator may select promotional offers from multiple sources and save them to the list of promotional offers in an embodiment.

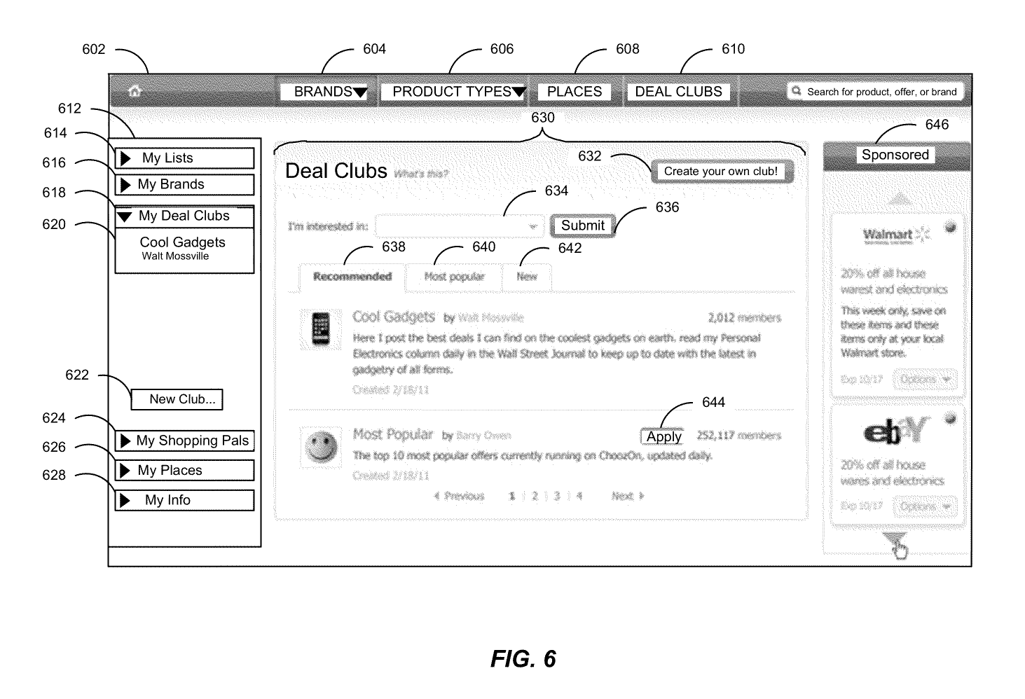

FIG. 5 presents a flowchart generally representing the steps undertaken in one embodiment with a graphical user interface for creating an offer group with members that share access to a list of promotional offers selected from a plurality of offer sources by a curator. At step 502, a window of a graphical user interface may be displayed on a computing device with user interface controls that create an offer group with members that share access to a list of promotional offers selected from multiple offer sources by a curator of the offer group. At step 504, an indication may be received that a user interface control was selected to create an offer group with members that share access to a list of promotional offers selected from multiple offer sources by a curator of the offer group. For example, a user interface button labeled “new club” 622 or “create your own club” 632 as depicted in FIG. 6 may be selected by a user input device that generates an indication received that a user interface control was selected to create an offer group.

At step 506, a request may be sent to create an offer group with members that share access to a list of promotional offers selected from multiple offer sources by a curator of the offer group. In an embodiment, the request may be sent by a client device such as client 202 of FIG. 2 to a server such as server 218 of FIG. 2. At step 508, a window of a graphical user interface may be displayed with user interface controls to assign attributes, the rules of curating offers, the rules of membership, the rules of visibility and the roles of the users for the offer group. In an embodiment, the attributes assigned to an offer group may include a name of the offer group, a text description of the offer group, an image representing the offer group, keywords associated with the offer group, commercial categories associated with the offer group and so forth.

At step 510, user inputs may be received that assign the attributes, the rules of curating offers, the rules of membership, the rules of visibility and the roles of the users for the offer group. At step 512, the attributes, the rules of curating offers, the rules of membership, the rules of visibility and the roles of the users may be saved for the offer group. In an embodiment, the attributes, the rules of curating offers, the rules of membership, the rules of visibility and the roles of the users for the offer group may be saved in a database. In various embodiments, those skilled in the art will appreciate that some attributes or rules may be assigned by default. In other embodiments, rules of visibility, rules of membership and/or roles of users may be optional or assigned by default. In various embodiments, roles can be changed so that members may be assigned the role of curator or curators may be assigned the role of member.

FIG. 6 presents an exemplary illustration generally representing a screen of a graphical user interface for displaying information about offer groups in an online service. The screen 602 in FIG. 6 shows the window of a graphical user interface for a web browser executing an offer application with an offer group referred to as a deal club as depicted on a button for deal clubs 610. In an embodiment, the window of the graphical user interface for the web browser executing the offer application 602 may display user interface elements for various offer sources such as a dropdown menu for brands 604, a dropdown menu for product types 606, a button for places 608, a button for deal clubs 610, and so forth. Further illustrated within the window of the graphical user interface for the web browser executing the offer application 602 is a personalization pane 612 which may display user interface elements for navigating among various offer sources personalized by a user of the online service, such as a dropdown menu for My Lists 614, a dropdown menu for My Brands 616, a dropdown menu for My Deal Clubs 618 that may show a list of deal clubs like the list illustrated in FIG. 6 with the deal club named Cool Gadgets 620, a user input button for creating a New Club 622, a dropdown menu for My Shopping Pals 624, a dropdown menu for My Places 626, a dropdown menu for My Info 628, and so forth.

Furthermore illustrated within the window of the graphical user interface for the web browser executing the offer application 602 is a content pane 630 which may display content such a list of promotional offers from the various offer sources, including those personalized by a user of the online offer service. In particular, content pane 630 of FIG. 6 illustrates a display of a list of offer groups that are visible and recommended to the user of the online offer service.

In general, a user of the online offer service may select the button for deal clubs 610 in various embodiments to navigate to a display of the list of offer groups that are visible to the user of the online offer service. For instance, when a user selects the button for deal clubs 610 in an embodiment, a list of offer groups that are visible to the user of the online offer service may be displayed. In such an embodiment, the consumer offer application 220 may verify for example that the user is a shopping pal of a curator of the offer group where the offer group is assigned a visibility to shopping pals. Moreover, the consumer offer application 220 may also check if the user is a member of the offer group and, if so, omit the offer group from the list of offer groups that are visible and displayed to the user, or alternatively display the offer group in the list of offer groups but without displaying a join button.

In yet another embodiment when a user selects the button for deal clubs 610, a list of offer groups that are visible to the user of the online offer service and that are associated with a product type selected as a user preference may be displayed. In yet other embodiments when a user selects the button for deal clubs 610, a recommended tab 638, a most popular tab 640 and a new tab 642 may be displayed as illustrated in FIG. 6 that may be selected by a user of the online offer service to display a list of offer groups that are visible to the user of the online offer service. If the user selects the recommended tab 638, a list of recommended offer groups may be displayed to the user of the online offer service. If the user selects the most popular tab 640, a list of most popular offer groups may be displayed to the user of the online offer service. And if the user selects the new tab 642, a list of new offer groups may be displayed to the user of the online offer service.

In any of these embodiments, those skilled in the art will appreciate that the list of offer groups displayed to a user may be selected by the online offer service using various criteria for selection including based on visibility to the user, user preferences for product types, user preferences for brands and so forth.

Note that a user may also search for an offer group, create an offer group or join an offer group. To search for an offer group, text may be input into a text input box 634 depicted in FIG. 6 and the submit button 636 may then be selected to send a request with a search string to find offer groups with search terms related to the search string. To create an offer group, the user input button for creating a New Club 622 may be selected, or the user input button 632 labeled “Create your own club!” may be selected. And to join an offer group, a user input button to join an offer group like button 644 may be selected to send a request to join the Most Popular deal club.

Finally, a sponsored search pane 646 is illustrated within the window of the graphical user interface for the web browser executing the offer application 602. The sponsored search pane 646 may display content such a list of promotional offers from sponsored advertisers such as brand advertisers as illustrated in FIG. 6.

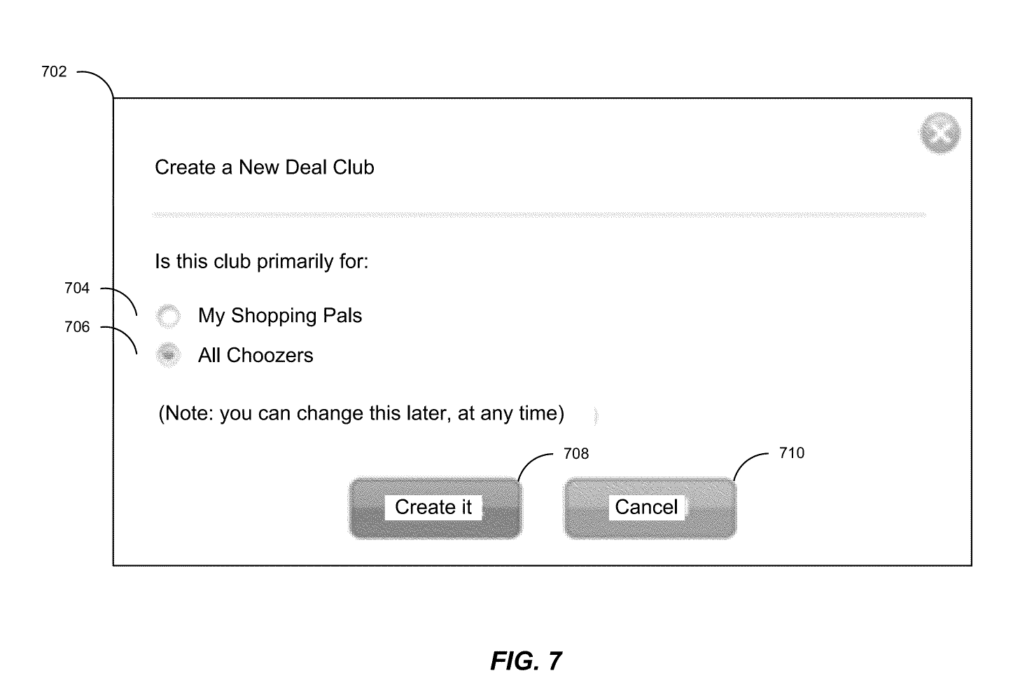

FIG. 7 presents an exemplary illustration generally representing a screen of a graphical user interface in one embodiment for creating an offer group. When a request is received to create a new offer group, the screen 702 of the graphical user interface for a web browser executing an offer application illustrated in FIG. 7 may be displayed. For instance, the screen of FIG. 7 may be displayed in response to receiving an indication that the user input button for creating a New Club 622 was selected, or the user input button 632 labeled “Create your own club!” was selected. Input box 704 labeled “My Shopping Pals” may be selected to assign a rule of visibility of shopping pals to the offer group, a rule of membership to require acceptance by the curator to the offer group, and a rule of curating offers not to require approval by the curator. Input box 706 labeled “All Choozers” may be selected to assign a rule of visibility of everyone to the offer group, a rule of membership to be open to everyone, and a rule of curating offers to require approval by the curator. Input button 708 labeled “Create it” may then be selected to create the offer group and assign the rule of visibility, the rule of membership and the rule of curating offers according to the selection of input box 704 “My Shopping Pals” or input box 706 “All Choozers”. Or input button 710 labeled “Cancel” may be selected to cancel the operation to create an offer group.

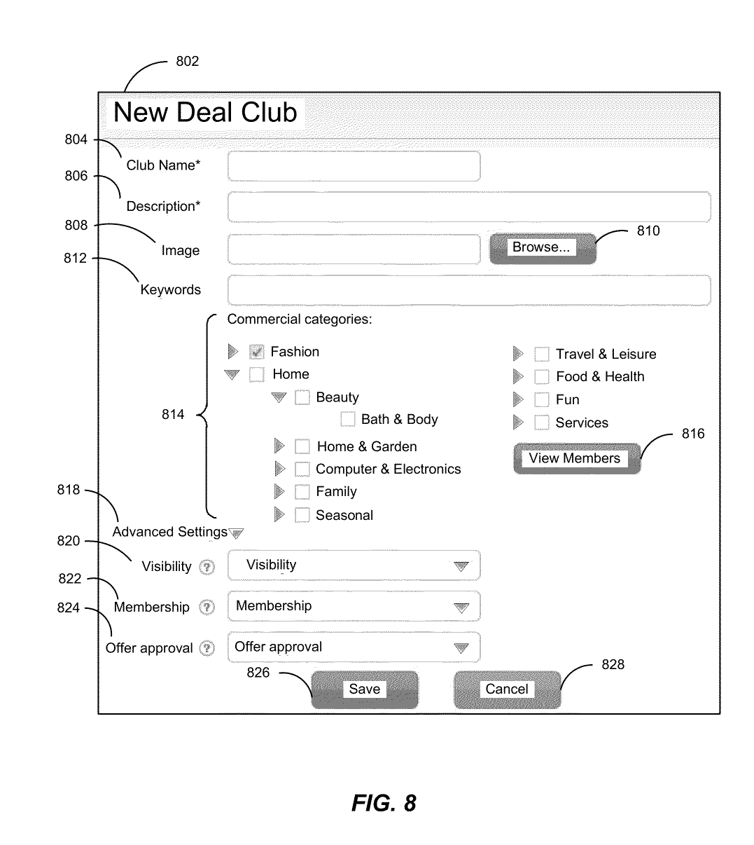

FIG. 8 presents an exemplary illustration generally representing a screen of a graphical user interface in various embodiments for assigning attributes, the rules of curating offers, the rules of membership, the rules of visibility and the roles of the users for the creation of a new offer group. When a request is received to create a new offer group, the screen 802 of the graphical user interface for a web browser executing an offer application illustrated in FIG. 8 may be displayed. For instance, the screen of FIG. 8 may be displayed in response to receiving an indication that the user input button 708 labeled “Create it” was selected. In this case, the rule of visibility, the rule of membership and the rule of curating offers according to the selection of user input box 704 “My Shopping Pals” or input box 706 “All Choozers” is assigned to the offer group, and the dropdown menu for Advanced Settings 818 of FIG. 8 may reflect these assigned settings for the rule of visibility, the rule of membership and the rule of curating offers in the dropdown menus for the visibility 820, the membership 822, and offer approval 824 respectively. Or in an alternate embodiment, the screen of FIG. 8 may be displayed in response to receiving an indication that the user input button for creating a New Club 622 was selected, or the user input button 632 labeled “Create your own club!” was selected.

In either embodiment, the attributes, the rules of curating offers, the rules of membership, the rules of visibility and the roles of the users may be assigned for the creation of a new offer group by selection of user input controls and by text entered through the graphical user interface for the web browser executing an offer application 802 illustrated in FIG. 8. The attributes assigned to an offer group may include a name of the offer group which may be entered into text input box 804 labeled “Club Name”, a text description of the offer group which may be entered into text input box 806 labeled “Description”, an image representing the offer group which may be selected by entering the address of the location of the image into text input box 808 labeled “Image” or by selection of the button 810 labeled “Browse” to find and select an address of the location of the image, keywords associated with the offer group which may be entered into text input box 812 labeled “Keywords”, and commercial categories 814 associated with the offer group which may be selected by navigating dropdown menus of the commercial categories 814 illustrated in FIG. 8 and selecting input boxes labeled by specific categories, and so forth.

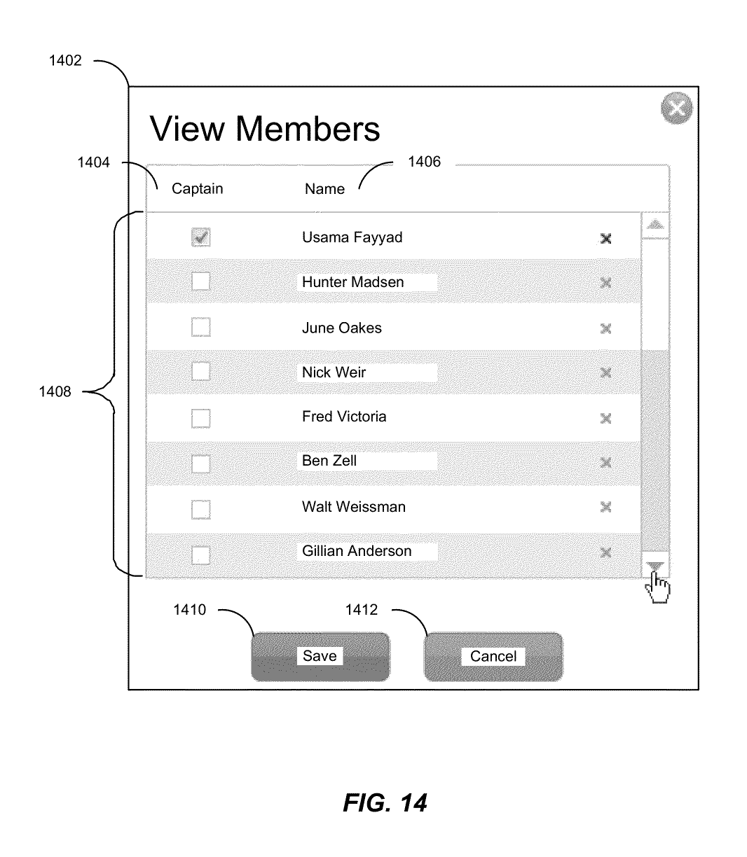

In addition to assigning attributes to an offer group, the membership of an offer group and their roles in an offer group may be displayed and edited by selecting user interface button 816 labeled “View Members”. This may be described in further detail below in conjunction with FIG. 14. In an embodiment, there may be two roles for an offer group: the role of curator and the role of member. By default, the role of curator may be assigned to the user of the online offer service who creates the offer group, and the role of member may be assigned to the other users who join the offer group.

Finally, the rules of visibility, the rules of membership and the rules of curating offers may be assigned to the offer group by selection of the dropdown menu 818 labeled “Advanced Settings” as illustrated in FIG. 8. The rules of visibility may be assigned by selection of dropdown menu 820 labeled “Visibility”. In an embodiment, a rule of visibility may be assigned a value of a group of users in the online offer service, such as “Shopping Pals” of the creator of the offer group, or may be assigned a value to be open without restriction to users of the online offer service, such as “Everyone”. The rules of membership may be assigned by selection of dropdown menu 822 labeled “Membership”. In an embodiment, a rule of membership may be assigned a value to be open without restriction to users of the online offer service, such as “Open”, or may be assigned a value to require acceptance of membership, such as “By Acceptance”. And the rules of curating offers may be assigned by selection of dropdown menu 824 labeled “Offer Approval”. In an embodiment, a rule of curating offers may be assigned a value to require approval of offers submitted for saving to the list of promotional offers of the offer group, such as “Required”, or may be assigned a value to not require approval of offers submitted, such as “Not Required”. Those skilled in the art will appreciate that additional rules of curating offers may be assigned in various embodiments, including a rule to select offers from one or more categories or product types, a rule to select offers from one or more brands, a rule to select offers from one or more locations or places, and so forth.

Also illustrated in FIG. 8 is input button 826 labeled “Save” that may be selected to persistently save the assigned attributes selected for the offer group and the assigned rules of visibility, assigned rules of membership and assigned rules of curating offers selected within the dropdown menu of Advanced Settings 818. Or input button 828 labeled “Cancel” may be selected to cancel the operation to assign attributes, the rules of curating offers, the rules of membership, the rules of visibility, and the roles of users to an offer group.

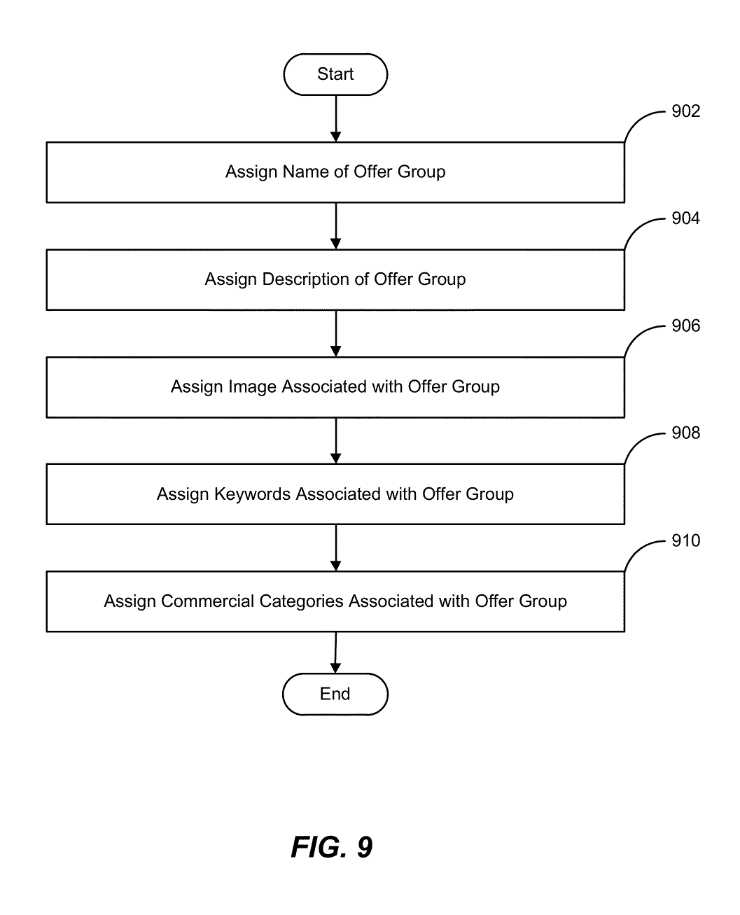

FIG. 9 presents a flowchart generally representing the steps undertaken in one embodiment for assigning attributes to an offer group with members that share access to a list of promotional offers selected from a plurality of offer sources by a curator. At step 902, a name of the offer group may be assigned. At step 904, a description of the offer group may be assigned. For example, the name of the offer group entered into a text input box such as text input box 804 labeled “Club Name” as illustrated in FIG. 8 above may be assigned to the offer group, and the a text description of the offer group entered into a text input box such as text input box 806 labeled “Description” as illustrated in FIG. 8 above may be assigned to the offer group.

At step 906, an image associated with the offer group may be assigned. In an embodiment, the image representing the offer group selected by entering the address of the location of the image into a text input box such as text input box 808 labeled “Image” as illustrated in FIG. 8 above or selected by the button 810 labeled “Browse” as illustrated in FIG. 8 above to find and select an address of the location of the image may be assigned to the offer group. At step 908, one or more keywords associated with the offer group may be assigned. And at step 910, one or more commercial categories associated with the offer group may be assigned. In an embodiment, keywords associated with the offer group entered into a text input box such as text input box 812 labeled “Keywords” as illustrated in FIG. 8 above may be assigned to the offer group, and commercial categories associated with the offer group selected by navigating dropdown menus of the commercial categories such as dropdown menus of commercial categories 814 illustrated in FIG. 8 above and selecting input boxes labeled by specific categories may be assigned to the offer group.

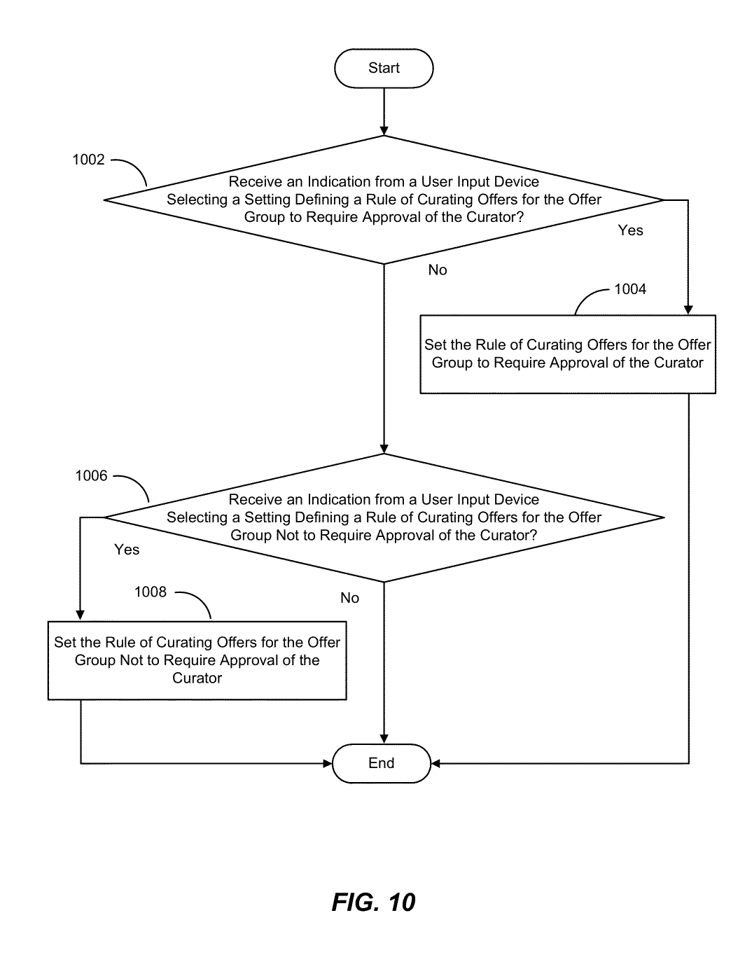

FIG. 10 presents a flowchart generally representing the steps undertaken in one embodiment for assigning rules of curating offers to an offer group with members that share access to a list of promotional offers selected from a plurality of offer sources. At step 1002, it may be determined whether an indication may be received from a user input device that a setting was selected defining a rule of curating offers for the offer group to require approval of the curator. If it is determined that an indication is received that a setting was selected defining a rule of curating offers for the offer group to require approval of the curator, then the rule of curating offers for the offer group may be set to require approval of the curator at step 1004, and processing may be finished for assigning rules of curating offers to an offer group. Otherwise, it may be determined at step 1006 whether an indication may be received from a user input device that a setting was selected defining a rule of curating offers for the offer group to not require approval of the curator. If not, then processing may be finished for assigning rules of curating offers to an offer group. If it is determined that an indication is received that a setting was selected defining a rule of curating offers for the offer group not to require approval of the curator, then the rule of curating offers for the offer group may be set to not require approval of the curator at step 1008, and processing may be finished for assigning rules of curating offers to an offer group.

Those skilled in the art will appreciate that additional rules of curating offers may be assigned in various embodiments, including a rule to select offers from one or more categories or product types, a rule to select offers from one or more brands, a rule to select offers from one or more locations or places, and so forth. For each additional rule of curating offers implemented in an embodiment, it may be determined whether an indication may be received from a user input device that a setting was selected defining such an additional rule of curating offers for the offer group, and, if so, assigning the selected setting to the additional rule of curating offers for the offer group.

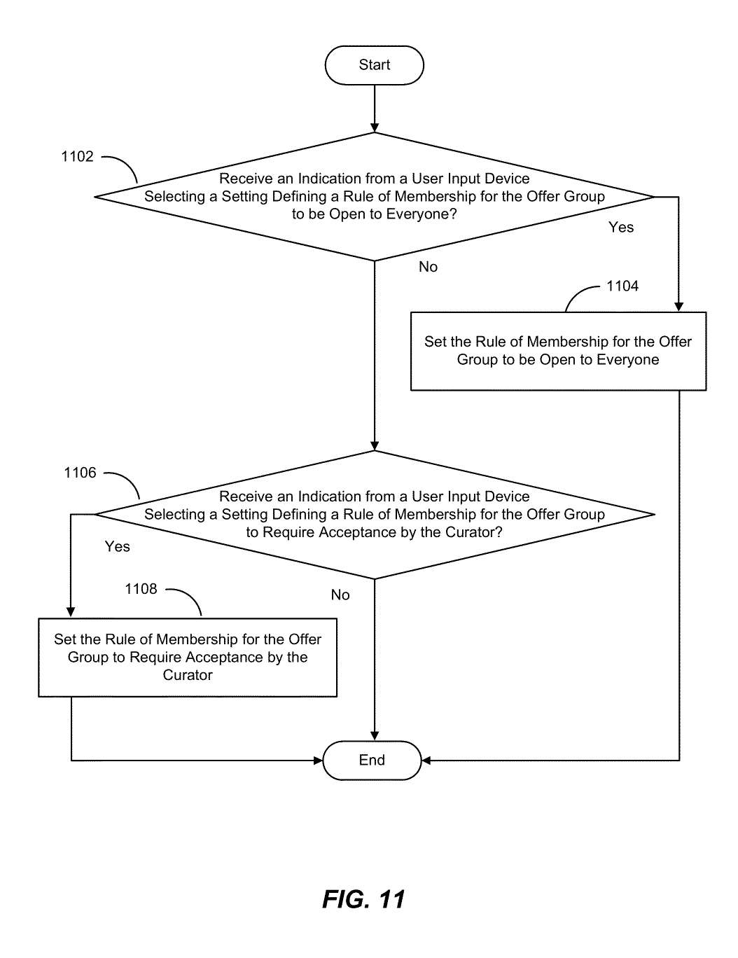

FIG. 11 presents a flowchart generally representing the steps undertaken in one embodiment for assigning rules of membership to an offer group with members that share access to a list of promotional offers selected from a plurality of offer sources. At step 1102, it may be determined whether an indication may be received from a user input device that a setting was selected defining a rule of membership for the offer group to be open to users of an online offer server. If it is determined that an indication is received that a setting was selected defining a rule of membership for the offer group to be open to users, then the rule of membership for the offer group may be set to be open to users of an online service at step 1104, and processing may be finished for assigning rules of membership to an offer group. Otherwise, it may be determined at step 1106 whether an indication may be received from a user input device that a setting was selected defining a rule of membership for the offer group to require acceptance by the curator. If not, then processing may be finished for assigning rules of membership to an offer group. If it is determined that an indication is received that a setting was selected defining a rule of membership for the offer group to require acceptance by the curator, then the rule of membership for the offer group may be set to require acceptance by the curator at step 1108, and processing may be finished for assigning rules of curating offers to an offer group. Those skilled in the art will appreciate that additional rules of membership may be assigned in various embodiments, including a rule to be open to a group of users related to a member such as Shopping Pals of a member, a rule to require approval by a curator to accept a group of users related to a member such as Shopping Pals of a member, a rule to be open to a group of users related to a curator such as Shopping Pals of a curator, and so forth. For each additional rule of membership implemented in an embodiment, it may be determined whether an indication may be received from a user input device that a setting was selected defining such an additional rule of membership for the offer group, and, if so, assigning the selected setting to the additional rule of membership for the offer group.

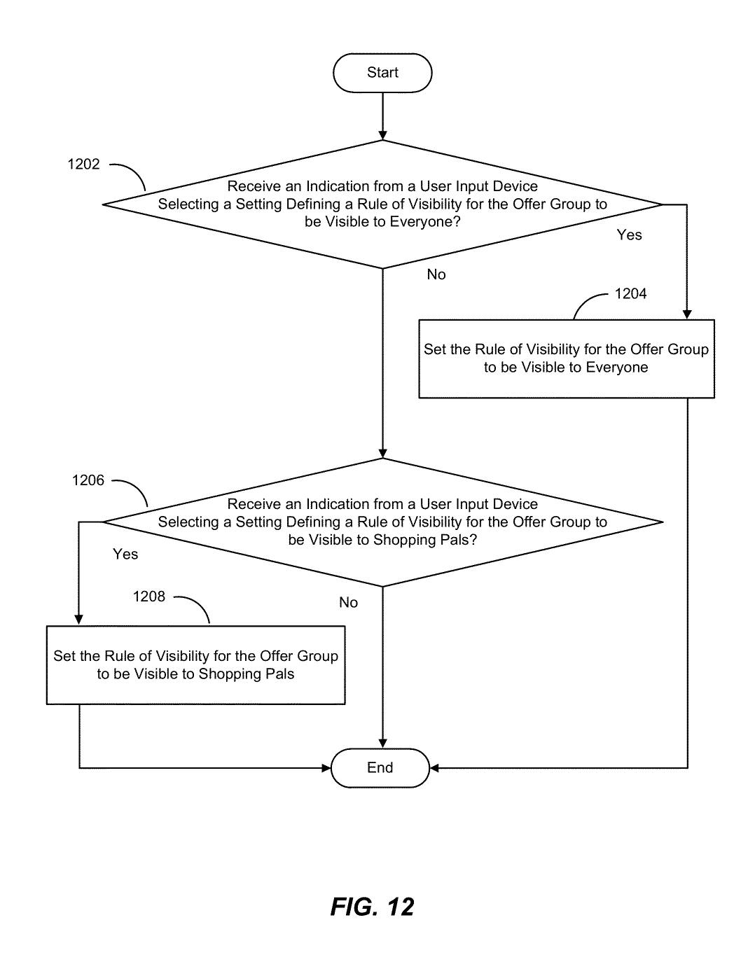

FIG. 12 presents a flowchart generally representing the steps undertaken in one embodiment for assigning rules of visibility to an offer group with members that share access to a list of promotional offers selected from a plurality of offer sources. At step 1202, it may be determined whether an indication may be received from a user input device that a setting was selected defining a rule of visibility for the offer group to be open to users of an online offer server. If it is determined that an indication is received that a setting was selected defining a rule of visibility for the offer group to be open to users, then the rule of visibility for the offer group may be set to be open to users of an online service at step 1204, and processing may be finished for assigning rules of visibility to an offer group. Otherwise, it may be determined at step 1206 whether an indication may be received from a user input device that a setting was selected defining a rule of visibility for the offer group to be open to a group of users related to the curator, such as Shopping Pals of the curator. If not, then processing may be finished for assigning rules of visibility to an offer group. If it is determined that an indication is received that a setting was selected defining a rule of visibility for the offer group to be open to a group of users related to the curator, then the rule of visibility for the offer group may be set to be open to a group of users related to the curator at step 1208, and processing may be finished for assigning rules of visibility to an offer group.

Those skilled in the art will appreciate that additional rules of visibility may be assigned in various embodiments, including a rule to be open to a group of users related to a member such as Shopping Pals of a member, a rule to require approval by a curator to be open to a group of users related to a member such as Shopping Pals of a member, a rule to require approval by a member to be open to a group of users related to the member such as Shopping Pals of a member, and so forth. For each additional rule of membership implemented in an embodiment, it may be determined whether an indication may be received from a user input device that a setting was selected defining such an additional rule of visibility for the offer group, and, if so, assigning the selected setting to the additional rule of visibility for the offer group.

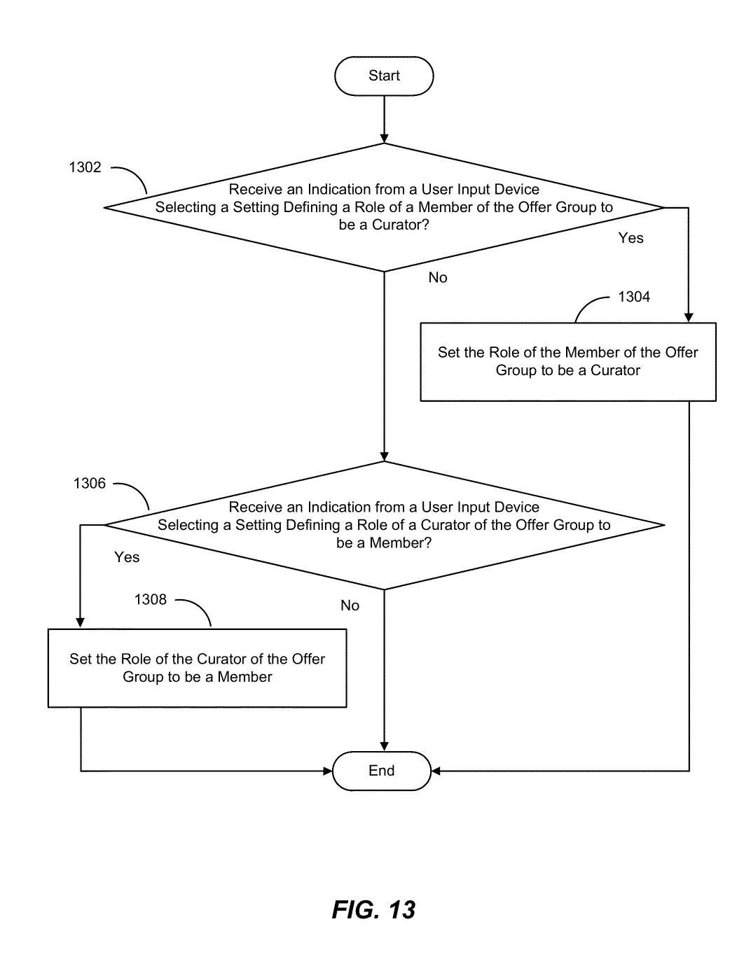

FIG. 13 presents a flowchart generally representing the steps undertaken in one embodiment for assigning roles of users of an offer group with members that share access to a list of promotional offers selected from a plurality of offer sources. At step 1302, it may be determined whether an indication may be received from a user input device that a setting was selected defining a role of a member of the offer group to be a curator. If it is determined that an indication is received that a setting was selected defining a role of the member of the offer group to be a curator, then the role of the member of the offer group may be set to be the role of a curator of the offer group at step 1304, and processing may be finished for assigning roles of users of an offer group. Otherwise, it may be determined at step 1306 whether an indication may be received from a user input device that a setting was selected defining a role of a curator of the offer group to be a member. If not, then processing may be finished for assigning roles of users of an offer group. If it is determined that an indication is received that a setting was selected defining the role of the curator of the offer group to be a member, then the role of the curator of the offer group may be set to be a member of the offer group at step 1308, and processing may be finished for assigning roles of users of an offer group.

Those skilled in the art will appreciate that additional roles of users of an offer group may be assigned in various embodiments, including a role of a user to be a restricted member of an offer group without privileges to curate promotional offers for the list of promotional offers shared by members of the offer group, a role of a user to be an emeritus member of an offer group with privileges to curate promotional offers without approval of the curator for the list of promotional offers shared by members of the offer group, a role of a user to be a restricted curator of an offer group without privileges to accept new members to the offer group, and so forth. For each additional role of users of an offer group implemented in an embodiment, it may be determined whether an indication may be received from a user input device that a setting was selected defining such an additional role of a user of the offer group, and, if so, assigning the selected setting to the additional role of user of the offer group.

FIG. 14 presents an exemplary illustration generally representing a screen of a graphical user interface in various embodiments for viewing membership and assigning roles of the users of an offer group. When a request is received to view the membership of an offer group, the screen of the graphical user interface for a web browser executing an offer application 1402 illustrated in FIG. 14 may be displayed. For instance, the screen of FIG. 14 may be displayed in response to receiving an indication that the user interface button 816 labeled “View Members” illustrated in FIG. 8 was selected. A list of members of the offer group may be displayed by name under the column labeled “Name” 1406 and an assignment of the role of curator may be displayed under the column labeled “Captain” 1404 where the input check boxes 1408 are marked with a checkmark as illustrated in FIG. 14. By default, the role of curator may be assigned to the user of the online offer service who creates the offer group, and the role of member may be assigned to the other users who join the offer group.

In addition to viewing membership, the unmarked input check boxes 1408 may be selected to mark the input check boxes and assign the role of curator to members of the offer group, and the marked input check boxes 1408 may be selected to unmark the input check boxes and assign the role of member to curators of the offer group. Also illustrated in FIG. 14 is input button 1410 labeled “Save” that may be selected to persistently save the assigned roles of users selected by marking and/or unmarking the input check boxes 1408. Or input button 1412 labeled “Cancel” may be selected to cancel the operation to assign roles of users selected by marking and/or unmarking the input check boxes 1408.

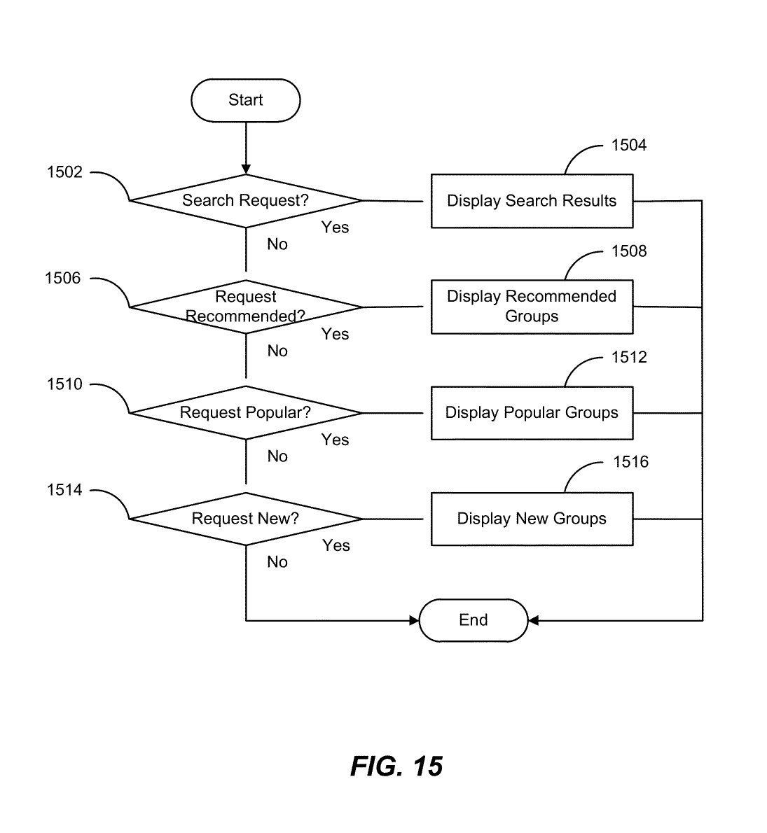

FIG. 15 presents a flowchart generally representing the steps undertaken in one embodiment for finding and displaying information about offer groups in an online service. At step 1502, it may be determined whether a search request was received to find offer groups. In an embodiment, text may be input into a text input box 634 depicted in FIG. 6 to search for an offer group, and the submit button 636 may then be selected to send a request with a search string to find offer groups with search terms related to the search string. If so, then search results may be received and displayed at step 1504, and processing may be finished for finding and displaying information about offer groups. If not, then it may be determined at step 1506 whether a request was received to find recommended offer groups. In an embodiment, a recommended tab 638 depicted in FIG. 6 may be selected to send a request to find recommended offer groups. If so, then a list of recommended offer groups may be received and displayed at step 1508, and processing may be finished for finding and displaying information about offer groups.

If it may be determined at step 1506 that a request was not received to find recommended offer groups, then it may be determined at step 1510 whether a request was received to find popular offer groups. In an embodiment, a popular tab 640 depicted in FIG. 6 may be selected to send a request to find popular offer groups. If so, then a list of popular offer groups may be received and displayed at step 1512, and processing may be finished for finding and displaying information about offer groups. Otherwise, it may be determined at step 1514 whether a request was received to find new offer groups. In an embodiment, a new tab 642 depicted in FIG. 6 may be selected to send a request to find new offer groups. If so, then a list of new offer groups may be received and displayed at step 1516, and processing may be finished for finding and displaying information about offer groups.

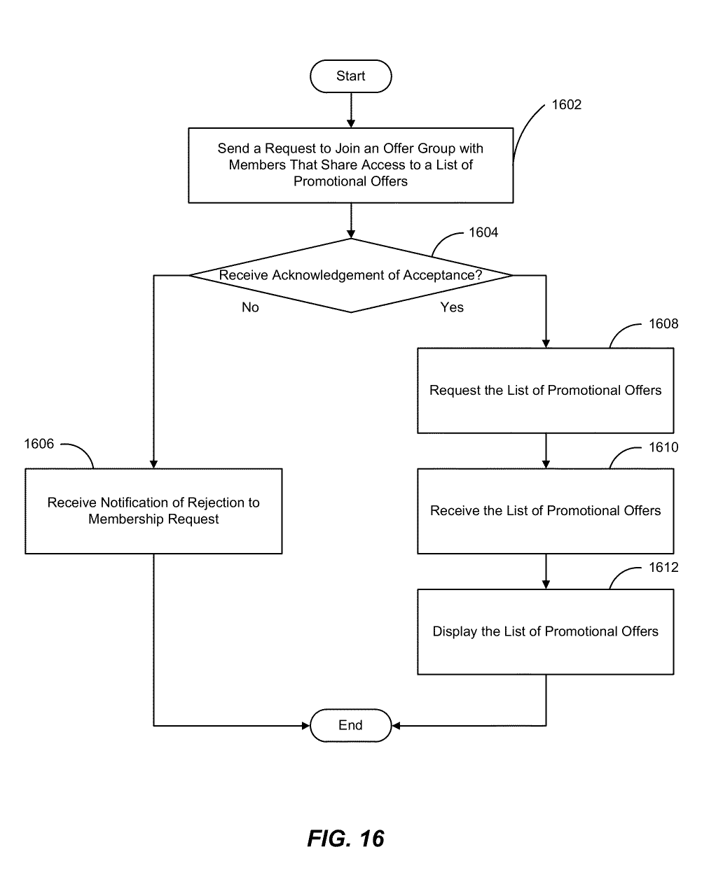

FIG. 16 presents a flowchart generally representing the steps undertaken in one embodiment for a user in an online service to join an offer group. At step 1602, a request may be sent to join an offer group with members that share access to a list of promotional offers. In an embodiment, an indication that a user interface control was selected to join an offer group may be received by the offer application user interface 208, and a request may be sent to the consumer offer application 220 to join an offer group with members that share access to a list of promotional offers. At step 1604, it may be determined whether an acknowledgement of acceptance was received. If not, then notification of rejection of the request to join the offer group may be received at step 1606. Otherwise, if it may be determined that an acknowledgement of acceptance was received, then a list of promotional offer for the offer group may be requested at step 1608. The list of promotional offer for the offer group may be received at step 1610, and the list of promotional offer for the offer group may be displayed at step 1612 and processing may be finished for a user to join an offer group.

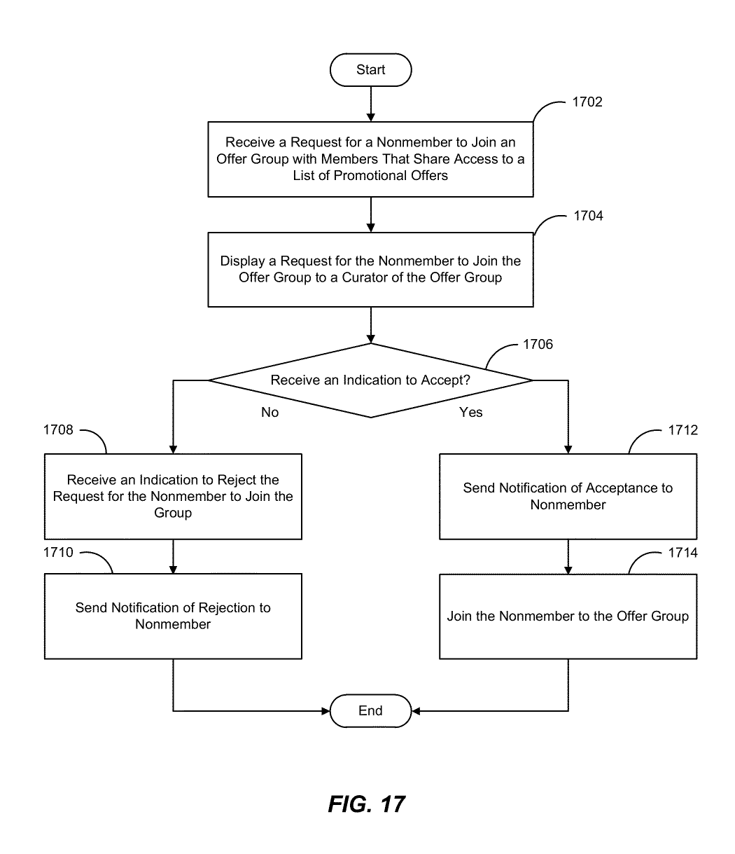

FIG. 17 presents a flowchart generally representing the steps undertaken in one embodiment for a curator of an offer group to process a request for a nonmember to join an offer group. The steps of FIG. 17 may be practiced in various embodiments where an offer group may be assigned a rule of membership that requires approval of a curator for a nonmember to join the offer group. At step 1702, a request for a nonmember to join an offer group with members that share access to a list of promotional offers may be received. In an embodiment, the offer group may have assigned a rule of membership that requires approval of a curator for a nonmember to join the offer group. The request for the nonmember to join the offer group may be displayed at step 1704 to a curator of the offer group.

At step 1706, it may be determined whether an indication was received that a user interface control was selected to accept the nonmember to join the offer group. In an embodiment, an indication that a user interface control was selected to accept the nonmember to join the offer group may be received by the offer application user interface 208. If so, then notification of acceptance of the nonmember to join the offer group may be sent at step 1712 and the nonmember may be joined to the offer group at step 1714. Otherwise, an indication may be received that a user interface control was selected to reject the request for the nonmember to join the offer group at step 1708. At step 1710, notification of rejection of the request for the nonmember to join the offer group may be sent, and processing may be finished for processing a request for a nonmember to join an offer group.

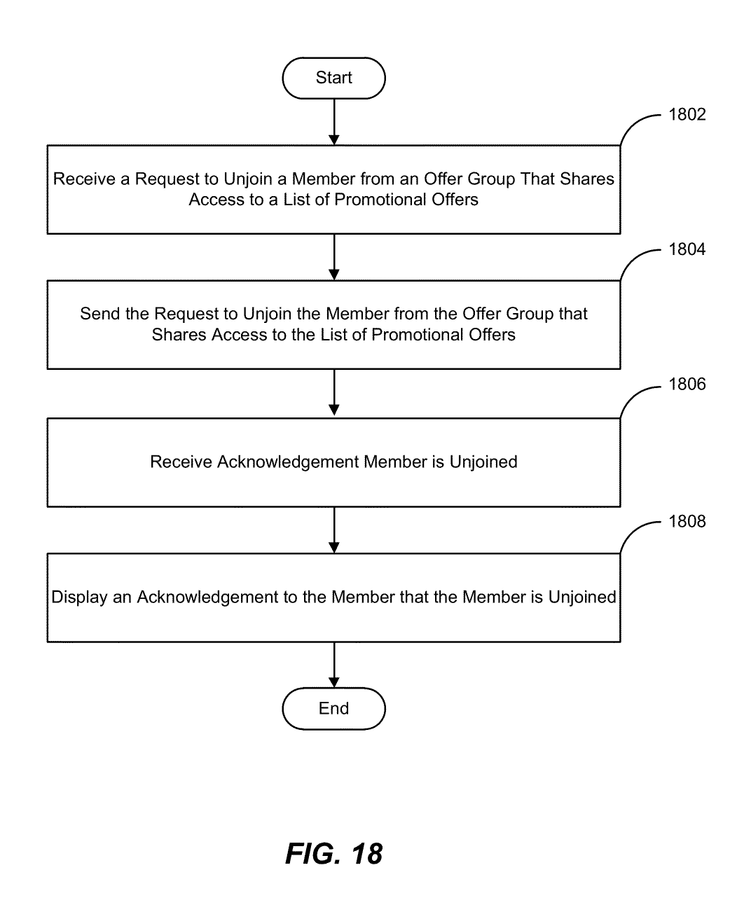

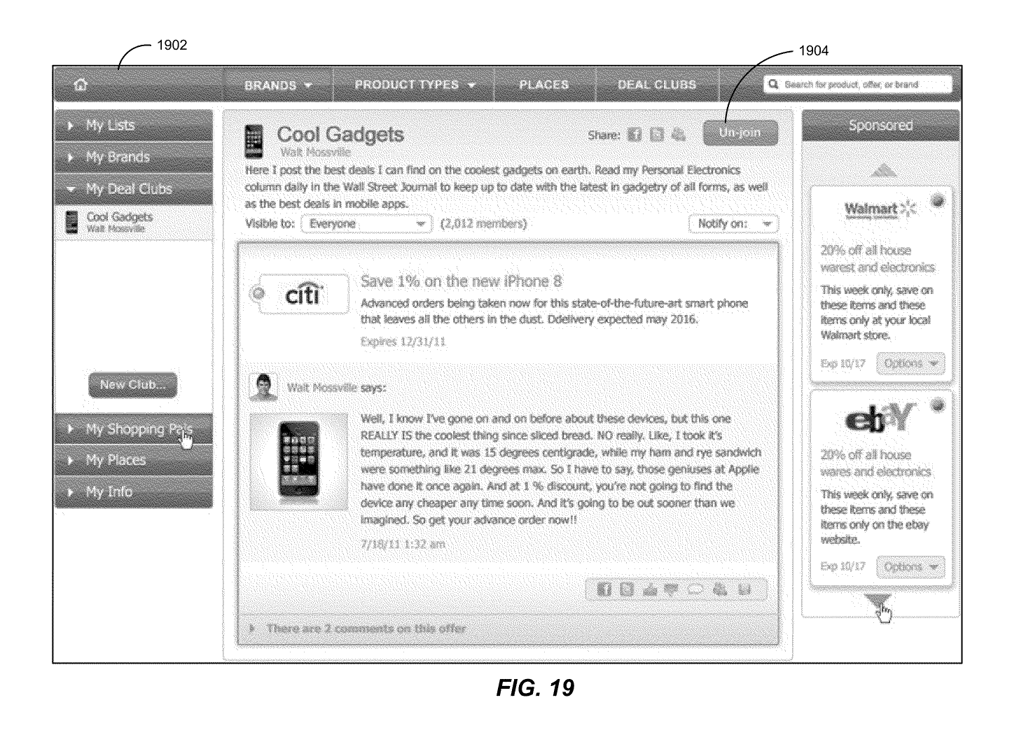

FIG. 18 presents a flowchart generally representing the steps undertaken in one embodiment for a member of an offer group to unjoin the offer group. At step 1802, a request may be received to unjoin a member from an offer group that shares access to a list of promotional offers, and the request may be sent at step 1804 to unjoin the member from the offer group that shares access to the list of promotional offers. In an embodiment, an indication that a user interface control was selected to unjoin the member from an offer group may be received by the offer application user interface 208, and the request may be sent to the consumer offer application 220 to unjoin the member from the offer group. For example, FIG. 19 is an exemplary illustration generally representing a screen of a graphical user interface in various embodiments for viewing an offer group and displaying a user interface control selectable to unjoin the offer group. The screen in FIG. 19 shows the window of a graphical user interface for a web browser executing an offer application 1902 with an offer group referred to as a deal club. Illustrated in FIG. 19 is a user interface control 1904 labeled “Un-join” which may be selected to request that the member be unjoined from the offer group.

An acknowledgement may be sent from the consumer offer application 220 that the member was unjoined from the offer group in an embodiment, and the acknowledgement that the member was unjoined from the offer group may be received at step 1806 by the offer application user interface 208. At step 1808, the acknowledgement that the member was unjoined from the offer group may be displayed to the member, and processing may be finished for a member of an offer group to unjoin the offer group.

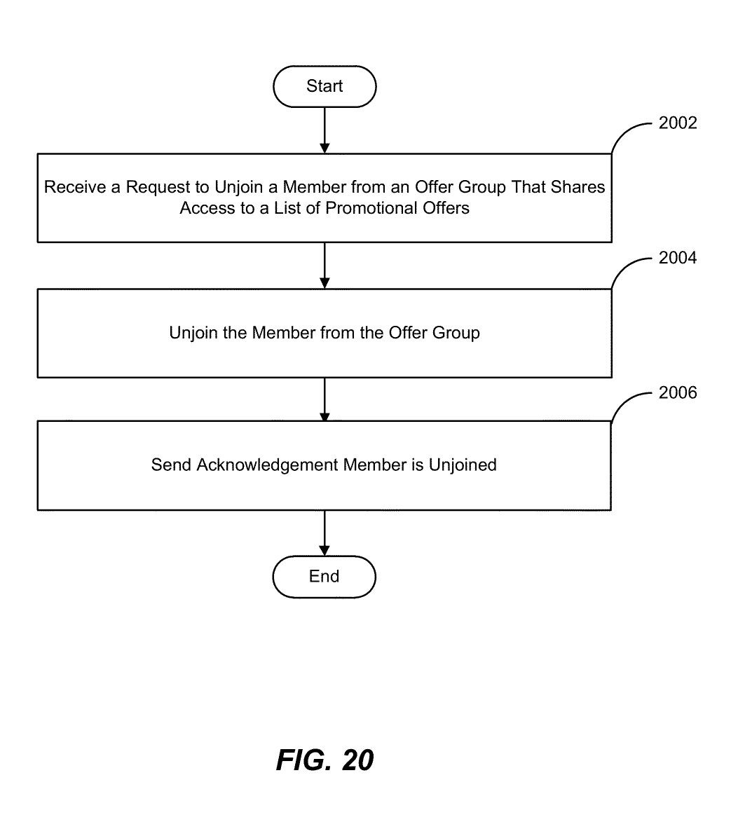

FIG. 20 presents a flowchart generally representing the steps undertaken in one embodiment to process a request for a member of an offer group to unjoin the offer group. At step 2002, a request may be received to unjoin a member from an offer group that shares access to a list of promotional offers. In an embodiment, the request to unjoin the member from the offer group may be sent by the offer application 206 to the consumer offer application 220. At step 2004, the member may be unjoined from the offer group. An acknowledgement may be sent from the consumer offer application 220 that the member was unjoined from the offer group in an embodiment. Accordingly, an acknowledgement that the member was unjoined from the offer group may be received at step 1808 by the offer application 206 and processing may be finished for a member of an offer group to unjoin the offer group.

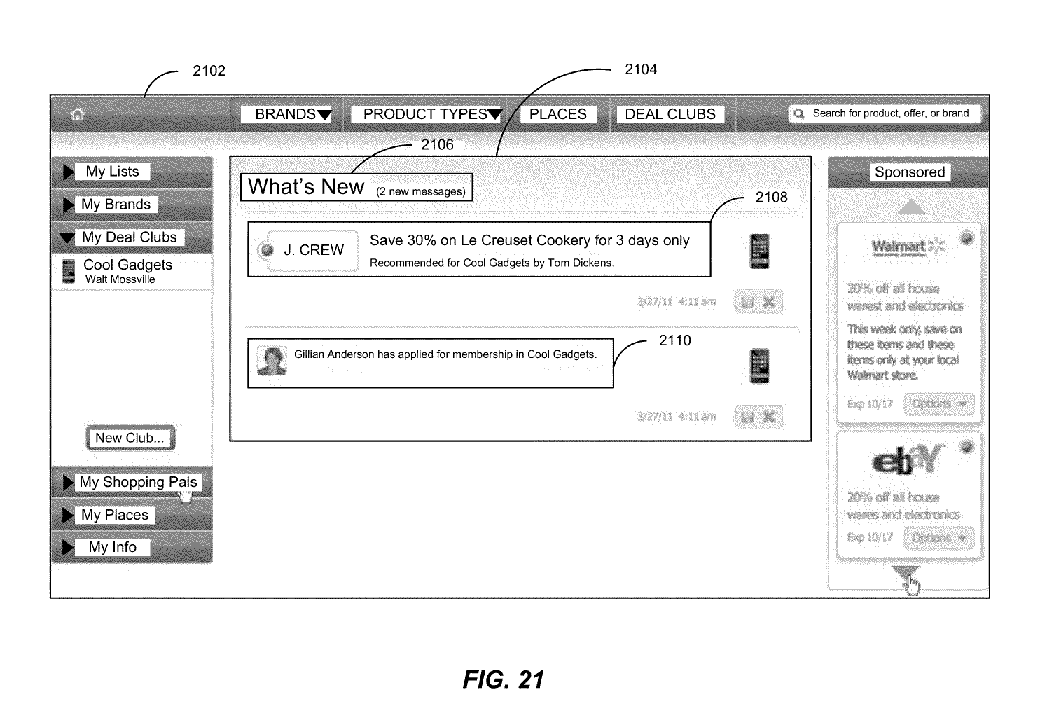

FIG. 21 presents an exemplary illustration generally representing a screen of a graphical user interface for displaying new messages for a curator of an offer group in an online service. The screen in FIG. 21 shows the window of a graphical user interface for a web browser executing an offer application 2102 and illustrates within the window of the graphical user interface a content pane 2104 which may display content such as new messages for a curator to view, including membership application requests and an approved promotional offer of the offer group. In particular, FIG. 21 illustrates the following content displayed within the content pane 2104: a “What's New” message 2106 that indicates the number of new messages, a message of a new offer 2108 approved for the list of promotional offers of the offer group, and a message of a membership application request 2110 for approval by the curator. In an embodiment, the message of a membership application request 2110 may be received for a nonmember to join an offer group as described above by step 1702 of FIG. 17, and the curator of an offer group may select this message for display to the curator of the offer group as described above by step 1704 of FIG. 17.

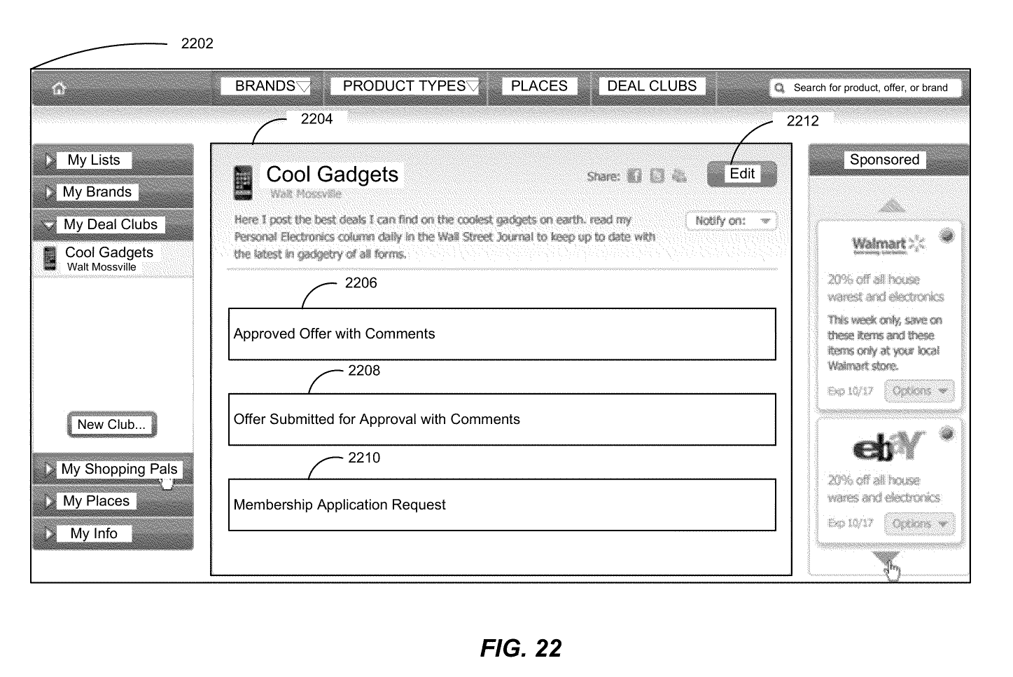

In addition to displaying new messages to a curator of an offer group as described in FIG. 21, messages may also be displayed to a curator of an offer group as content displayed for the offer group to the curator. FIG. 22 is an exemplary illustration generally representing a screen of a graphical user interface for displaying an offer group to a curator of the offer group. The screen in FIG. 22 shows the window of a graphical user interface 2202 for a web browser executing an offer application and illustrates within the window of the graphical user interface a content pane 2204 which may display content such as offers and messages for a curator to view, including an approved offer 2206 added to the list of promotional offers of the offer group, an offer submission request 2208 for approval, a membership application request 2210 for approval, and a button 2212 labeled “Edit” for editing attributes, the rules of curating offers, the rules of membership, the rules of visibility and the roles of the users for an offer group.

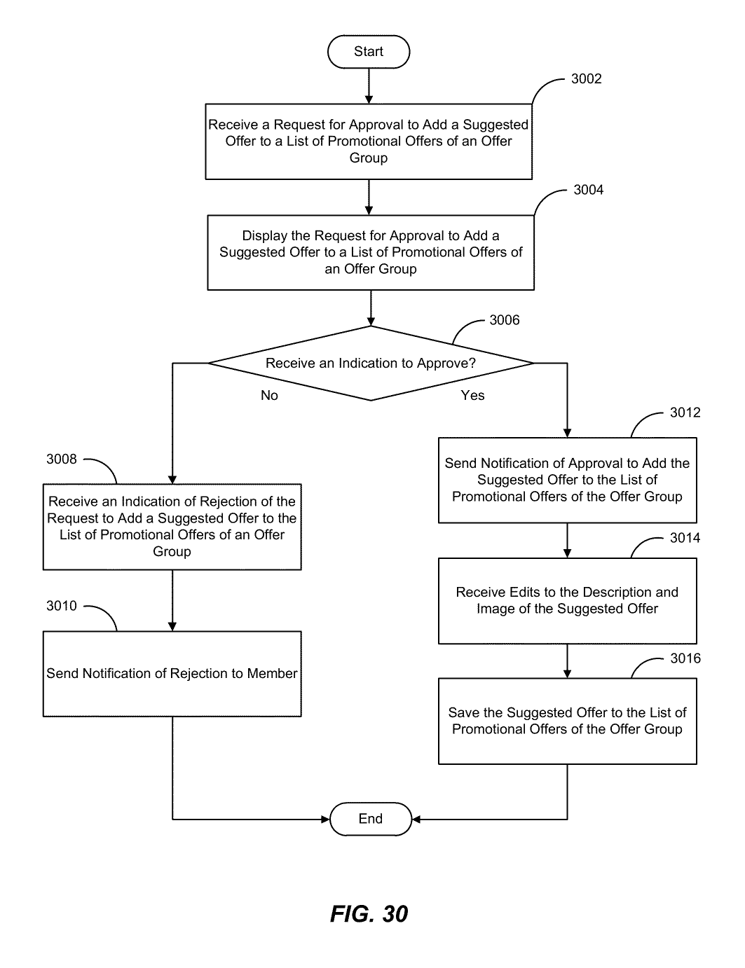

In an embodiment, the approved offer 2206 may be received as described below by step 3012 of FIG. 30. Similarly, the message of an offer submission request 2208 for approval by the curator may be received by a curator as described below by step 3002 of FIG. 30, and the curator of an offer group may select this message for display of a window of a graphical user interface with user input controls to approve or reject the request as described below by step 3006 of FIG. 30. The message of a membership application request 2210 may be received for a nonmember to join an offer group as described above by step 1702 of FIG. 17, and the curator of an offer group may select this message for display of a window of a graphical user interface with user input controls to accept or reject the membership application request as described above by step 1704 of FIG. 17.

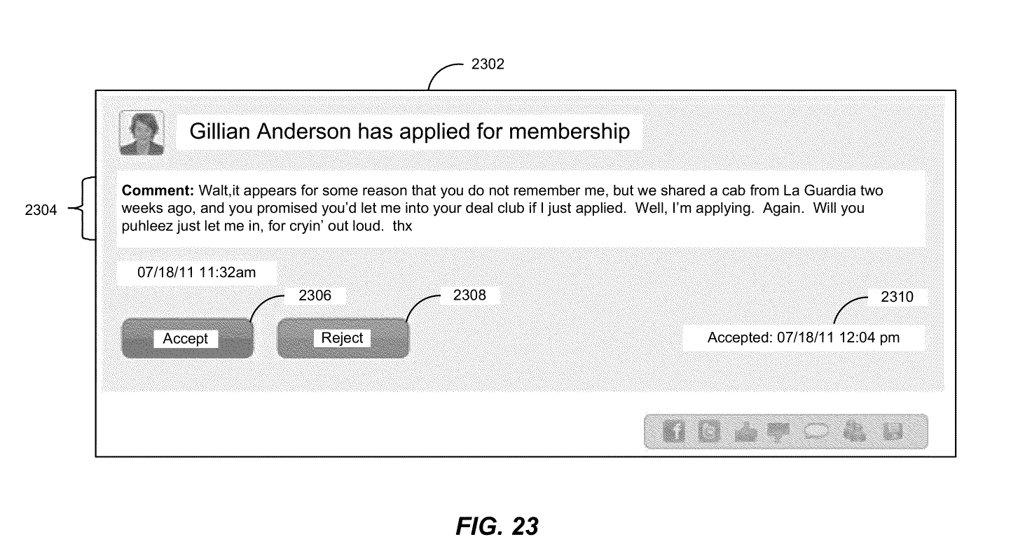

FIG. 23 is an exemplary illustration generally representing a window of a graphical user interface with user input controls to accept or reject a membership application request. The window of a graphical user interface 2302 in FIG. 23 illustrates the content of a comment of a membership application request 2304 from the nonmember requesting approval of the membership application request. Also illustrated in FIG. 23 is input button 2306 labeled “Accept” that may be selected to accept the membership application request. In an embodiment, the curator of an offer group may select the “Accept” input button 2306 to send notification of acceptance to the nonmember as described above by step 1712 of FIG. 17 and to join the nonmember to the offer group as described above by step 1714 of FIG. 17. In this case, the window of the graphical user interface 2302 may also display a message box 2310 indicating the date and time the membership application request was accepted as illustrated in FIG. 23. Or input button 2308 labeled “Reject” may be selected to reject the membership application request and to send notification of rejection to the nonmember as described above by step 1710 of FIG. 17. In this case, the window of the graphical user interface 2302 may also display a message box 2310 indicating the date and time the membership application request was rejected.

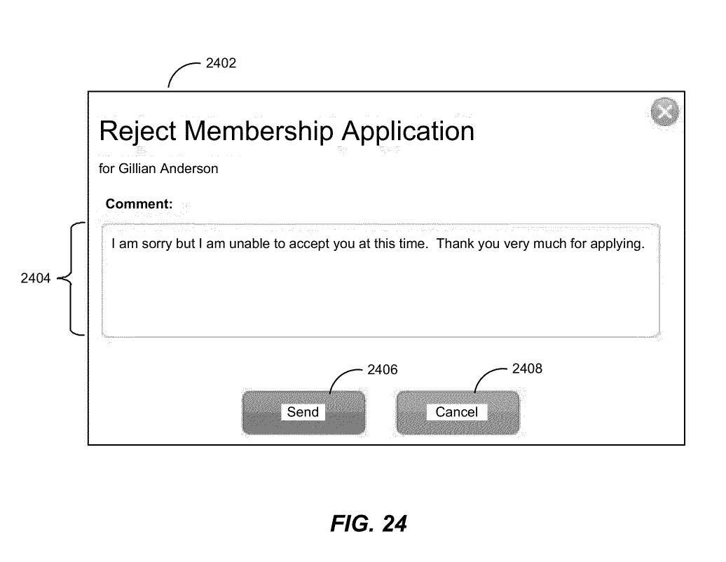

FIG. 24 is an exemplary illustration generally representing a window of a graphical user interface for rejecting a membership application request. The window of a graphical user interface 2402 in FIG. 24 illustrates the content of a comment of rejection of a membership application request 2404. Also illustrated in FIG. 24 is input button 2406 labeled “Send” that may be selected to send a message of rejection of the membership application request. In an embodiment, the curator of an offer group may select the “Send” input button 2406 to send notification of rejection to the nonmember as described above by step 1710 of FIG. 17. Or input button 2408 labeled “Cancel” may be selected to cancel the message of rejection of the membership application request.

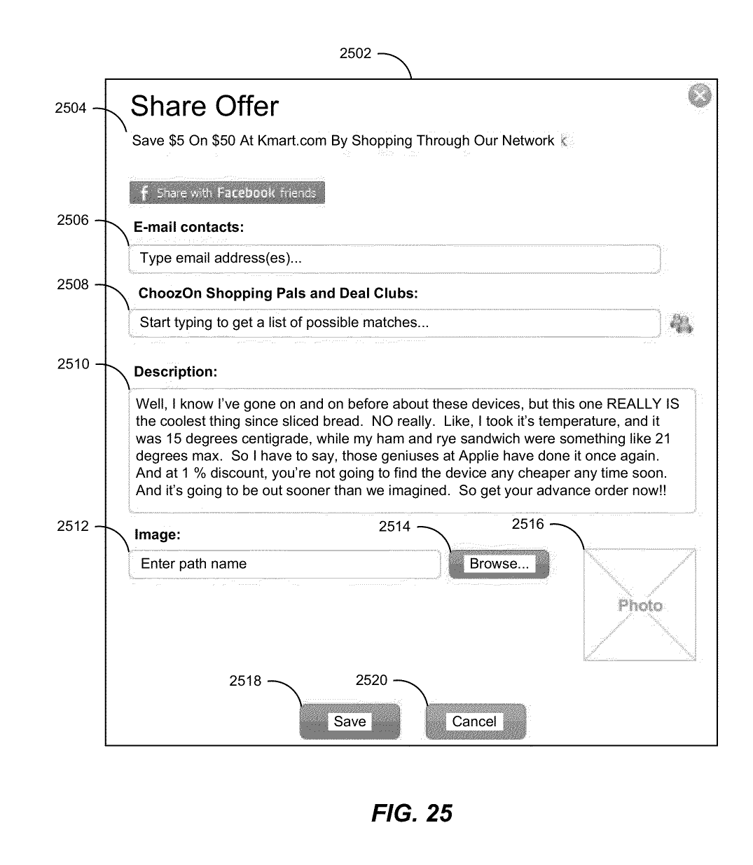

FIG. 25 is an exemplary illustration generally representing a window of a graphical user interface for sharing an offer, including submitting a request for approval of a suggested offer to be added to the list of promotional offers of the offer group. The window of the graphical user interface 2502 in FIG. 25 illustrates an offer 2504 for sharing, a text input box 2506 to enter email addresses of email contacts, a text input box 2508 to enter names of offer groups or names of users of the online offer service that may be Shopping Pals, a text input box 2510 to enter a description of the offer, a text input box 2512 to enter the address of the location of an image that may be associated with the offer or by selection of the button 2514 labeled “Browse” to find and select an address of the location of the image, and an image 2516. Also illustrated in FIG. 25 is input button 2518 labeled “Save” that may be selected to save the information entered and received in text input boxes 2506-2516. Or input button 2520 labeled “Cancel” may be selected to cancel saving the information entered and received in text input boxes 2506-2516 and sharing the offer.

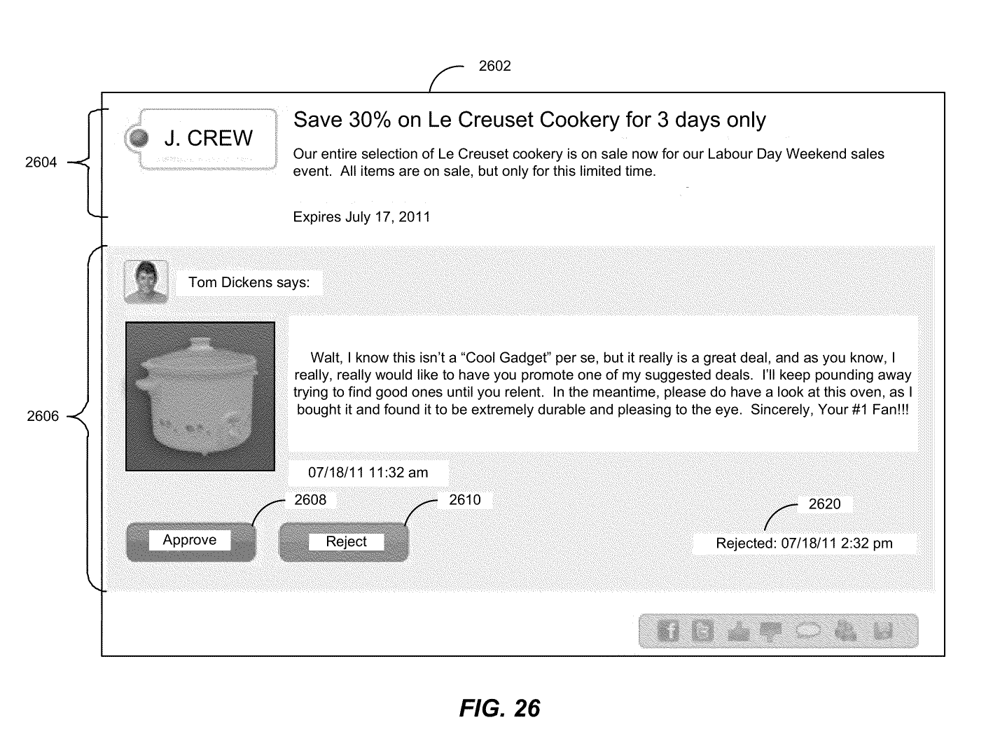

FIG. 26 is an exemplary illustration generally representing a window of a graphical user interface for displaying a message of an offer submission request for approval of a suggested offer to be added to the list of promotional offers of the offer group. The window of the graphical user interface 2602 in FIG. 26 illustrates an offer 2604 and the content of a message of an offer submission request 2606 for approval of a suggested offer to be added to the list of promotional offers of the offer group, including a comment requesting approval of the suggested offer to be added to the list of promotional offers of the offer group. Also illustrated in FIG. 26 is input button 2608 labeled “Approve” that may be selected to approve the suggested offer to be added to the list of promotional offers of the offer group. In an embodiment, the curator of an offer group may select the “Approve” input button 2608 to approve the suggested offer to be added to the list of promotional offers as described below by step 3006 of FIG. 30 and to edit the description of the suggested offer and save the suggested offer to the list of promotional offers of the offer group as described below by steps 3014 and 3016 of FIG. 30. In this case, the content of the message of an offer submission request 2606 may also display a message box 2620 indicating the date and time that the offer submission request was accepted. Or input button 2610 labeled “Reject” may be selected to reject the offer submission request 2606 and to send notification of rejection of the offer submission request to the member who submitted the request as described below by step 3010 of FIG. 30. In this case, the content of the message of an offer submission request 2606 may also display a message box 2620 indicating the date and time that the offer submission request was rejected as illustrated in FIG. 26.

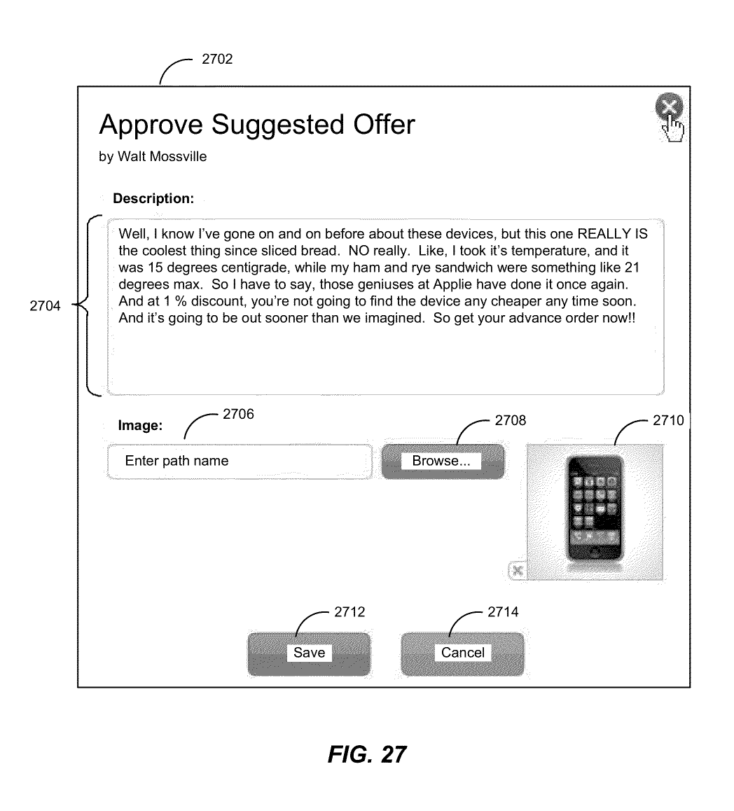

FIG. 27 is an exemplary illustration generally representing a window of a graphical user interface for approving a suggested offer to be added to a list of promotional offers of an offer group. The window of a graphical user interface 2702 in FIG. 27 illustrates a description 2704 of the suggested offer that may be edited, a text input box 2706 for entering the path name for an image associated with the suggested offer, an input button 2708 labeled “Browse” for browsing for a path name for an image, and an image 2710 selected to be associated with the suggested offer.

Also illustrated in FIG. 27 is input button 2712 labeled “Save” that may be selected to save the description 2704 and the image 2710 of the suggested offer to the list of promotional offers of the offer group. In an embodiment, the curator of an offer group may select the “Save” input button 2712 to save the suggested offer to the list of promotional offers of the offer group as described below by step 3016 of FIG. 30. Or input button 2714 labeled “Cancel” may be selected to cancel saving the description 2704 and the image 2710 of the suggested offer to the list of promotional offers of the offer group.

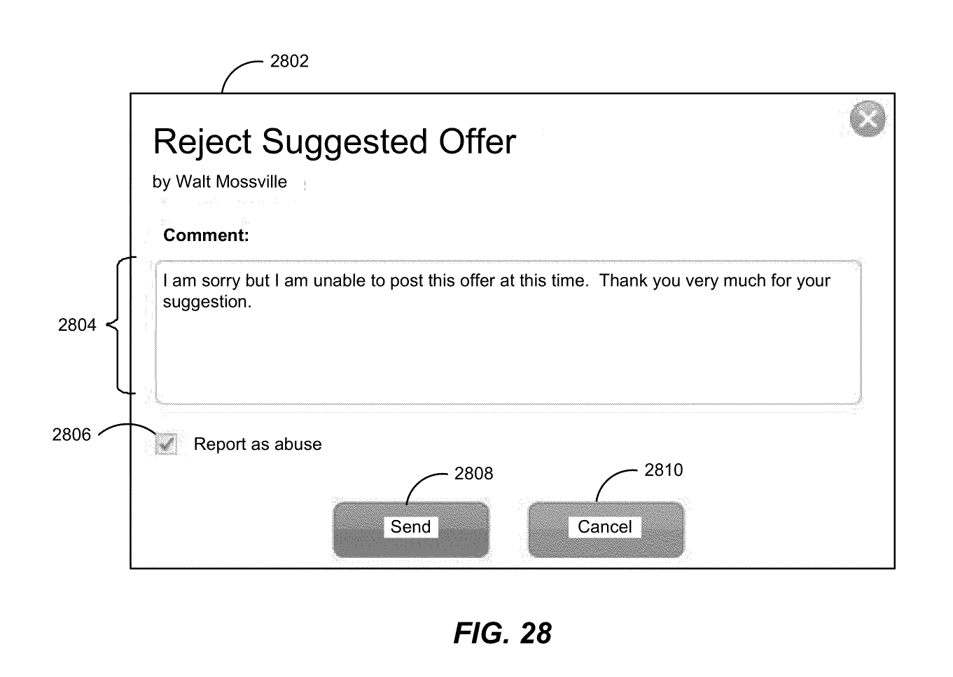

FIG. 28 is an exemplary illustration generally representing a window of a graphical user interface for sending a message of rejection of an offer approval request for a suggested offer. The window of a graphical user interface 2802 in FIG. 28 illustrates the content of a comment 2804 of rejection of an offer approval request from the curator of the offer group. There may also be an input box 2806 as illustrated in FIG. 28 that may be check to report abuse of a member submitting suggested offers that are not appropriate for the offer group.

Also illustrated in FIG. 28 is input button 2808 labeled “Send” that may be selected to send a message of rejection of an offer approval request for a suggested offer. In an embodiment, the curator of an offer group may select the “Send” input button 2808 to send notification of rejection to the member as described below by step 3010 of FIG. 30. Or input button 2810 labeled “Cancel” may be selected to cancel the message of rejection of an offer approval request for a suggested offer.

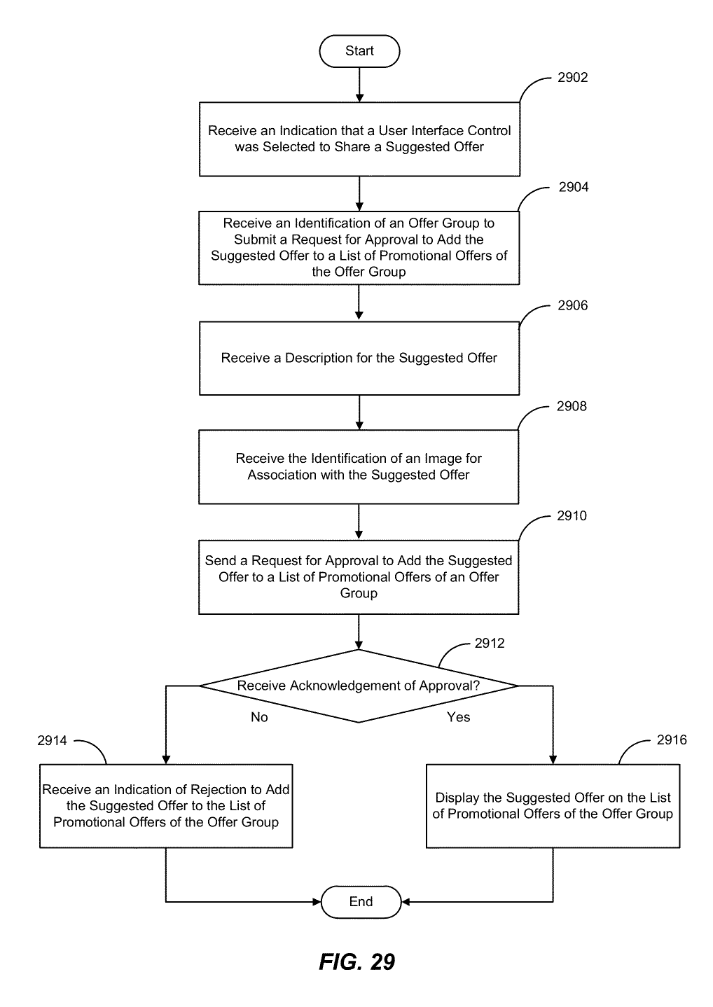

FIG. 29 presents a flowchart generally representing the steps undertaken in one embodiment for a member of an offer group to request approval for a suggested offer to be added to the list of promotional offers of the offer group. The steps of FIG. 29 may be practiced in various embodiments where an offer group may be assigned a rule of curating offers for the offer group to require approval of the curator. At step 2902, an indication that a user interface control was selected to share a suggested offer may be received. In an embodiment, an indication that a user interface control was selected to share an offer may be received by the offer application user interface 208 and a window of a graphical user interface may be displayed to a user with user interface controls to share an offer, like the window of the graphical user interface described in conjunction with FIG. 25. At step 2904, an identification of an offer group may be received for submitting the request for approval to add the suggested offer to the list of promotional offers of the offer group. In an embodiment, text input box 2508 described in conjunction with FIG. 25 may receive text entered by a user to identify an offer group for submitting the request for approval to add the suggested offer to the list of promotional offers of the offer group. At step 2906, a description may be received for the suggested offer. In an embodiment, text input box 2510 described in conjunction with FIG. 25 may receive text entered by a user to describe the suggested offer. At step 2908, the identification of an image may be received for association with the suggested offer. In an embodiment, text input box 2512 described in conjunction with FIG. 25 may receive a path name of an image entered by a user for association with the suggested offer.

At step 2910, a request may be sent for approval to add a suggested offer to a list of promotional offers of an offer group. In an embodiment, an indication may be received that a user interface control, such as input button 2518 of FIG. 25, was selected to send the request for approval of a suggested offer to a curator of an identified offer group, and a request may be sent by the offer application user interface 208 to the consumer offer application 220 to process the request. At step 2912, it may be determined whether an acknowledgement of approval was received. If not, then notification of rejection of the request for approval of a suggested offer may be received at step 2914. Otherwise, if it may be determined that an acknowledgement of approval was received, then the suggested offer may be displayed on a list of promotional offer for the offer group at step 2916 and processing may be finished for requesting approval of a suggested offer to be added to a list of promotional offers of an offer group.

FIG. 30 presents a flowchart generally representing the steps undertaken in one embodiment for a curator of an offer group to approve a request to add a suggested offer to the list of promotional offers of the offer group. At step 3002, a request may be received for approval to add a suggested offer to a list of promotional offers of an offer group, and the request for approval to add a suggested offer to a list of promotional offers of an offer group may be displayed at step 3004. In an embodiment, a window of a graphical user interface may be displayed to a user with the offer approval request and with user interface controls to approve or reject the suggested offer, like the window of the graphical user interface described in conjunction with FIG. 26.

At step 3006, it may be determined whether an indication was received that a user interface control was selected to approve the request to add a suggested offer to the list of promotional offers of the offer group. If so, then notification of approval to add the suggested offer to the list of promotional offers of the offer group may be sent at step 3012. And, a window of a graphical user interface may be displayed for approving a suggested offer, like window 2702 of FIG. 27. At step 3014, edits to the description and image of the suggested offer may be received. In an embodiment, description 2704 of the suggested offer in FIG. 27 may be edited, and the text input box 2706 may be edited for entering the path name for a different image associated with the suggested offer. And the suggested offer may be saved to the list of promotional offers of the offer group at step 3016.

If it may be determined at step 3006 that an indication was not received to approve the request to add a suggested offer to the list of promotional offers of the offer group, then an indication of rejection of the request to add a suggested offer to the list of promotional offers of an offer group may be received at step 3008. At step 3010, notification of rejection may be sent to the member who submitting the offer approval request. In an embodiment, a window of a graphical user interface for sending a message of rejection of an offer approval request for a suggested offer may be displayed like the window of the graphical user interface 2802 in FIG. 28, and a comment 2804 of rejection of an offer approval request may be entered by the curator of the offer group.

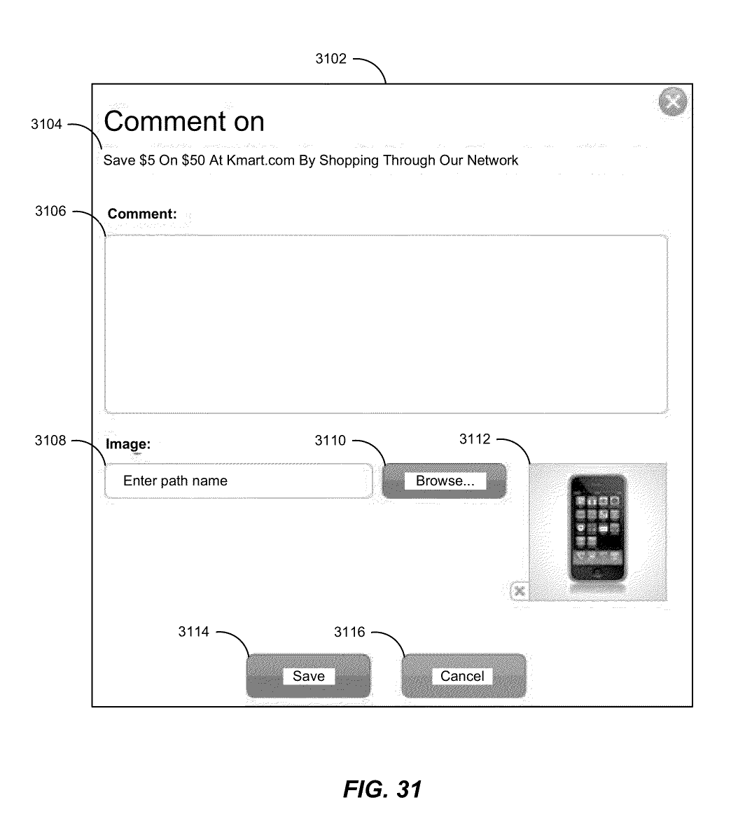

FIG. 31 is an exemplary illustration generally representing a window of a graphical user interface for commenting on an offer in a list of promotional offers of an offer group. The window of a graphical user interface 3102 in FIG. 31 illustrates an offer 3104, a text input box 3106 for entering a comment about the offer, a text input box 3108 for entering the path name for an image associated with the offer, an input button 3110 labeled “Browse” for browsing for a path name for an image, and an image 3112 selected to be associated with the offer.

Also illustrated in FIG. 31 is input button 3114 labeled “Save” that may be selected to save the comment about the offer entered into the text input box 3106 and the image 3112 selected to be associated with the offer. In an embodiment, a member of an offer group may select the “Save” input button 3114 to save the comment about the offer and the image selected to be associated with the offer. Or input button 3116 labeled “Cancel” may be selected to cancel saving the comment about the offer and the image selected to be associated with the offer.

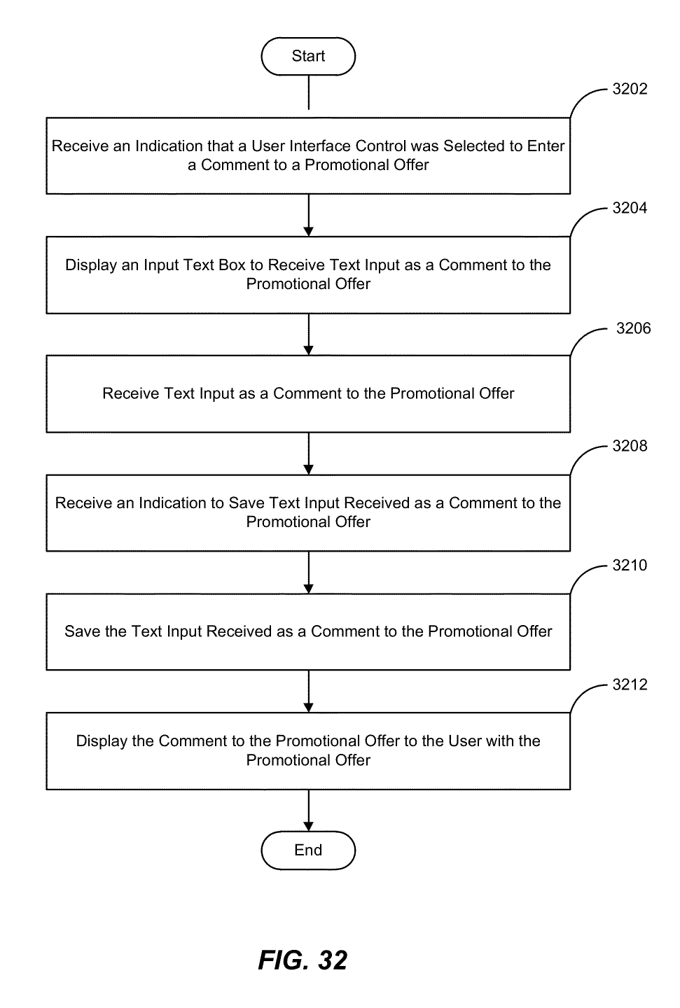

FIG. 32 presents a flowchart generally representing the steps undertaken in one embodiment for commenting on an offer in a list of promotional offers of an offer group. At step 3202, an indication may be received that a user interface control was selected to enter a comment to a promotional offer of an offer group. For instance, an input button may be selected for commenting on an offer in an embodiment, and a window of a graphical user interface may be displayed to a user with a text input box for entering a comment about the offer, like the window of the graphical user interface 3102 described above in conjunction with FIG. 31. Accordingly, an input text box may be displayed at step 3204 to receive text input as a comment to the promotional offer, and text input may be received at step 3206 as a comment to the promotional offer.

At step 3208, an indication may be received that a user interface control was selected to save the text input received as a comment to the promotional offer. In an embodiment, a member of an offer group may select the “Save” input button 3114 described above in conjunction with FIG. 31 to save the comment about the offer. And the text input received as a comment to the promotional offer may be saved at step 3210, for instance, as part of the information of a group offer 258 in server storage 246 described in conjunction with FIG. 2. At step 3212, the comment to the promotional offer may be displayed to the user with the promotional offer.

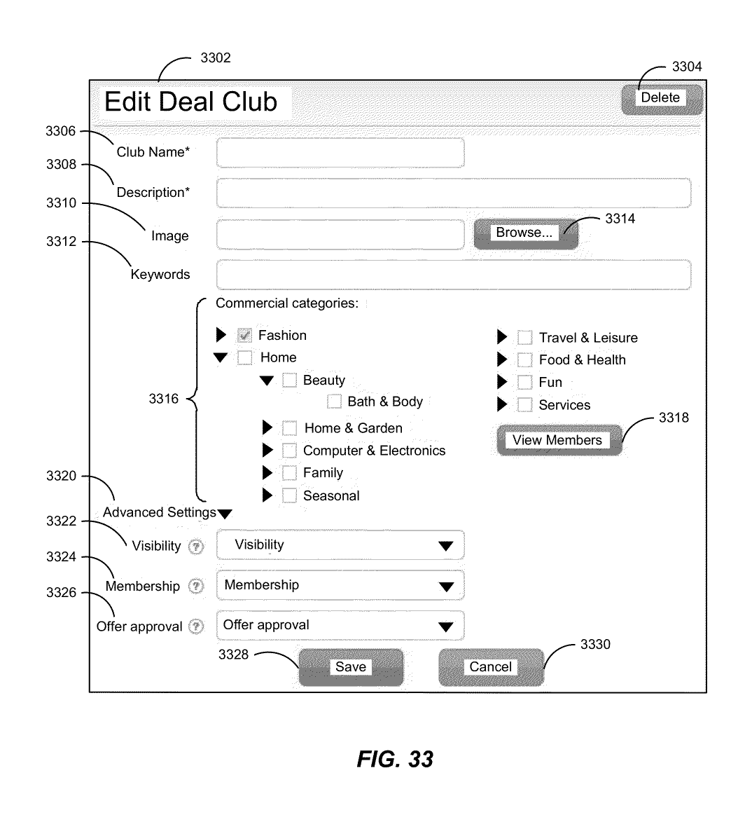

FIG. 33 is an exemplary illustration generally representing a screen of a graphical user interface in various embodiments for editing the attributes, the rules of curating offers, the rules of membership, the rules of visibility and the roles of the members of an offer group. When a request is received to edit an offer group, the screen of the graphical user interface for a web browser executing an offer application 3302 illustrated in FIG. 33 may be displayed. For instance, the screen of FIG. 33 may be displayed in response to receiving an indication that the user input button 2212 labeled “Edit” described in conjunction with FIG. 22 was selected. In an embodiment, the attributes, the rules of curating offers, the rules of membership, the rules of visibility and the roles of the users may be edited for the offer group by selection of user input controls and by text entered through the graphical user interface for the web browser executing an offer application 3202 illustrated in FIG. 33. The attributes edited for an offer group may include a name of the offer group which may be entered into text input box 3306 labeled “Club Name”, a text description of the offer group which may be entered into text input box 3308 labeled “Description”, an image representing the offer group which may be selected by entering the address of the location of the image into text input box 3310 labeled “Image” or by selection of the button 3314 labeled “Browse” to find and select an address of the location of the image, keywords associated with the offer group which may be entered into text input box 3312 labeled “Keywords”, and commercial categories 3316 associated with the offer group which may be selected by navigating dropdown menus of the commercial categories 3316 illustrated in FIG. 33 and selecting input boxes labeled by specific categories, and so forth.

In addition to editing attributes to an offer group, the membership of an offer group and their roles in an offer group may be displayed and edited by selecting user interface button 3318 labeled “View Members”. This may be described in further detail above in conjunction with FIG. 14. Moreover, the rules of visibility, the rules of membership and the rules of curating offers may be edited for the offer group by selection of the dropdown menu 3320 labeled “Advanced Settings” as illustrated in FIG. 33. The rules of visibility may be edited by selection of dropdown menu 3322 labeled “Visibility”. The rules of membership may be edited by selection of dropdown menu 3324 labeled “Membership”. And the rules of curating offers may be edited by selection of dropdown menu 3326 labeled “Offer Approval”.

Also illustrated in FIG. 33 is input button 3328 labeled “Save” that may be selected to persistently save the edited attributes selected for the offer group and the assigned rules of visibility, assigned rules of membership and assigned rules of curating offers selected within the dropdown menu of Advanced Settings 3320. Or input button 3330 labeled “Cancel” may be selected to cancel the operation to edit attributes, the rules of curating offers, the rules of membership, the rules of visibility, and the roles of users to an offer group.

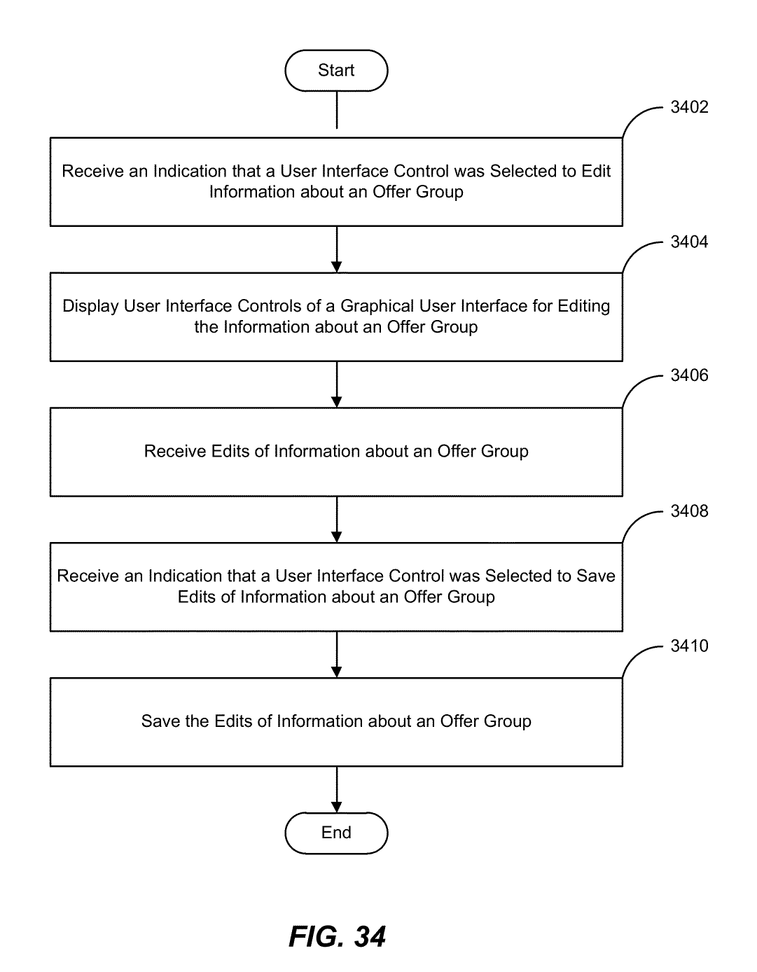

FIG. 34 presents a flowchart generally representing the steps undertaken in one embodiment for editing information about an offer group, including the attributes, the rules of curating offers, the rules of membership, the rules of visibility and the roles of the members of an offer group. At step 3402, an indication may be received that a user interface control was selected to edit information about an offer group. For instance, an indication may be received that the user input button 2212 labeled “Edit” described in conjunction with FIG. 22 was selected. At step 3404, user interface controls of a graphical user interface may be displayed for editing the information about an offer group. In an embodiment, the user interface controls, including text input boxes, of the graphical user interface illustrated in FIG. 33 may be displayed for editing the information about an offer group such as the attributes, the rules of curating offers, the rules of membership, the rules of visibility and the roles of the users for the offer group.

At step 3406, edits of the information about an offer group may be received. An indication may be received at step 3408 that a user interface control was selected to save edits of information about an offer group, and the edits of information about an offer group may be saved at step 3410. In an embodiment, an input button such as the Save input button 3328 illustrated above in FIG. 33 may be selected to persistently save the edited information about the offer group such as the attributes, the assigned rules of visibility, assigned rules of membership and assigned rules of curating offers.

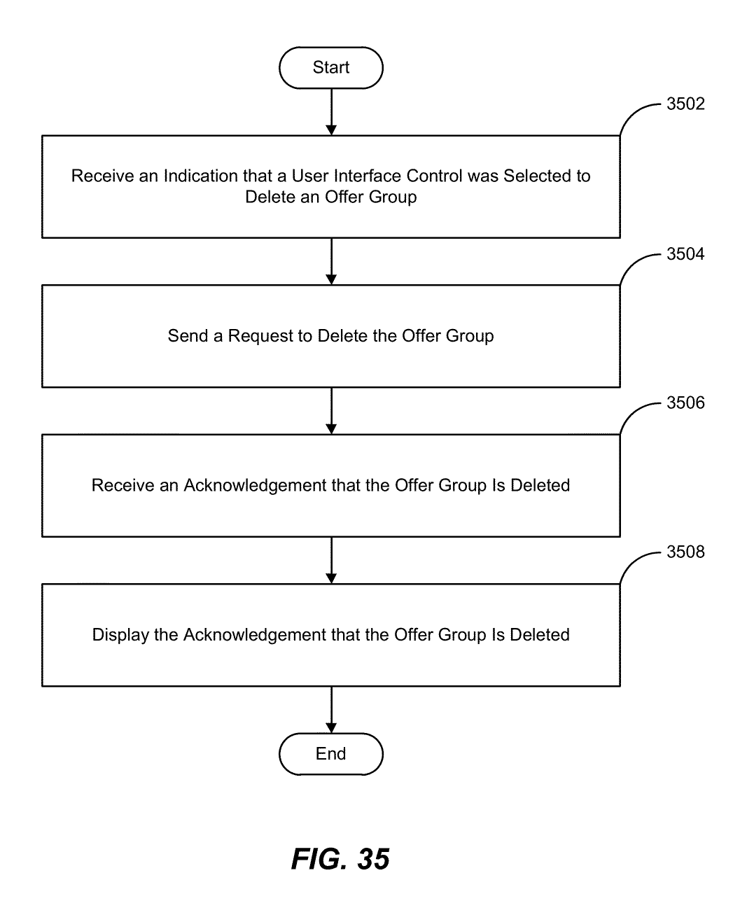

FIG. 35 presents a flowchart generally representing the steps undertaken in one embodiment on a client device for deleting an offer group in an online offer service. At step 3502, an indication may be received that a user interface control was selected to delete an offer group, and a request to delete the offer group may be sent at step 3504. In an embodiment, an indication that a user interface control was selected to delete the offer group may be received by the offer application user interface 208, and the offer application 206 may send the request to the consumer offer application 220 to delete the offer group. At step 3506, an acknowledgment may be received that the offer group is deleted, and the acknowledgement that the offer group is deleted may be displayed at step 3508. In an embodiment, an acknowledgement that the offer group is deleted may be sent by the consumer offer application 220 to the offer application 206, and the acknowledgement may be displayed by the offer application user interface 208.

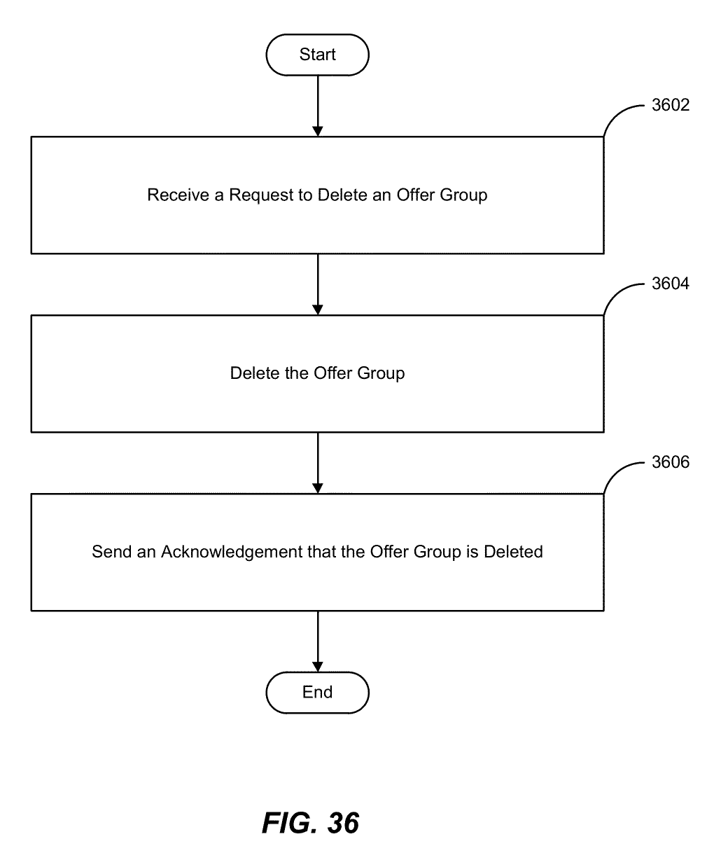

FIG. 36 presents a flowchart generally representing the steps undertaken in one embodiment on a server for deleting an offer group in an online offer service. At step 3602, a request may be received to delete an offer group. In an embodiment, the consumer offer application 220 may receive the request from the offer application 206 to delete the offer group. At step 3604, the offer group may be deleted. For instance, the consumer offer application 220 executing on an offer server 218 may delete the offer group. And at step 3606, an acknowledgment may be sent that the offer group is deleted. In an embodiment, an acknowledgement that the offer group is deleted may be sent by the consumer offer application 220 to the offer application 206.

Thus the present invention may provide a user interface for a member of an offer group to find and join offer groups of interest, and browse through curated offers pertaining to the offer group to more effectively find the offers desired of interest. Any member may submit an offer of interest pertaining to the offer group that may be approved and added to the list of promotional offers shared with other members of the group. Moreover, the user interface may conveniently support additional rules for membership of the offer group, additional rules for curating the offer list of the offer group, and/or additional rules for visibility of the offer group. Those skilled in the art will appreciate that there may be implementations of the user interface for offer clubs that may include other navigation controls for creating offer groups, managing offer groups and browsing the promotional offers of offer groups.

As can be seen from the foregoing detailed description, the present invention provides a system and method of creating and managing offer groups that curate an offer list of promotional offers from multiple offer sources in an online service. Any user may create and manage an offer group which curates a list of promotional offers from multiple offer sources, such as brands, product types, shopping pals, offer lists, etc. Importantly, the invention may flexibly allow curating a list of offers pertaining to an offer group by a curator or a group of members. Any user who has an interest may create a group which others may join to participate in curating offers of interest to the group. Or users may identify and join offer groups of interest, and then browse lists pertaining to those interests procured by others who share those same interests. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-implemented method for providing a curated list of offers, comprising:
receiving a request from a member of an offer group to obtain a list of a plurality of offers curated for the offer group according to at least one rule of curating the plurality of offers for the offer group;
retrieving the list of the plurality of offers curated for the offer group; and
serving the list of the plurality of offers curated for the offer group to display on a computing device.

2. The method of claim 1 further comprising:
receiving the list of the plurality of offers curated for the offer group to display on the computing device; and
displaying the list of the plurality of offers curated for the offer group to display on the computing device.

3. A computer-implemented method for providing a curated list of offers, comprising:
receiving a request to create an offer group to curate a list of a plurality of offers;
creating the offer group to curate the list of the plurality of offers according to at least one rule of curating the plurality of offers for the offer group; and
storing on a computer-readable medium the offer group to curate the list of the plurality of offers and the at least one rule for curating the list of the plurality of offers.

4. The method of claim 3 further comprising assigning the at least one rule of curating the plurality of offers for the offer group to require approval by a curator.

5. The method of claim 3 further comprising assigning at least one rule of visibility of the offer group.

6. The method of claim 5 wherein the assigning the at least one rule of visibility of the offer group comprises assigning the at least one rule of visibility of the offer group to be visible to a restricted plurality of users.

7. The method of claim 3 further comprising assigning at least one rule of membership of the offer group.

8. The method of claim 7 wherein the assigning the at least one rule of membership of the offer group comprises assigning the at least one rule of membership of the offer group to require acceptance by a curator.

9. The method of claim 3 further comprising assigning at least one role of a user of the offer group.

10. The method of claim 9 wherein the assigning the at least one role of the user of the offer group comprises assigning the at least one role of the user of the offer group to be a curator.

11. A computer-implemented method for providing a curated list of offers, comprising:
receiving a request from a nonmember to join an offer group having a curated list of a plurality of offers;
receiving an indication to accept the nonmember to join the offer group having the curated list of the plurality of offers according to at least one rule of membership for the offer group;
adding the nonmember to the offer group having the curated list of the plurality of offers according to at least one rule of membership for the offer group; and
storing on a computer-readable medium a list of group members of the offer group having the curated list of the plurality of offers.

12. The method of claim 11 further comprising retrieving the list of the plurality of offers.

13. The method of claim 11 further comprising displaying the list of the plurality of offers on a computing device.

14. A computer-implemented method for providing a curated list of offers, comprising:
receiving a request from a member of an offer group submitting an offer for approval to add the offer to a list of a plurality of offers of the offer group;
receiving an indication to approve adding the offer to the list of the plurality of offers of the offer group;
adding the offer to the list of the plurality of offers of the offer group; and
storing on a computer-readable medium the list of the plurality of offers of the offer group.

15. The method of claim 14 further comprising:
sending notification of approval to add the offer to the list of the plurality of offers of the offer group;
receiving edits to a description of the offer; and
saving the edits to the description of the offer.

16. A computer-implemented method for providing a curated list of offers, comprising:
receiving a request to find an offer group having a curated list of a plurality of offers;
finding at least one offer group having the curated list of the plurality of offers by matching at least one attribute associated with a user and at least one attribute of the at least one offer group;
retrieving a list of the at least one offer group matching the at least one attribute associated with the user and the at least one attribute of the at least one offer group; and
serving the list of the at least one offer group to display on a device.

17. The method of claim 16 wherein receiving the request to find the offer group having the curated list of the plurality of offers comprises receiving a request to find at least one recommended offer group having a curated list of a plurality of offers.

18. The method of claim 16 wherein receiving the request to find the offer group having the curated list of the plurality of offers comprises receiving a request to find at least one popular offer group having a curated list of a plurality of offers.

19. The method of claim 16 wherein receiving the request to find the offer group having the curated list of the plurality of offers comprises receiving a request to find at least one new offer group having a curated list of a plurality of offers.

20. A computer-readable storage medium having computer-executable instructions for performing the method comprising:
receiving a request to perform an operation on an offer group having a curated list of a plurality of offers;
performing the operation on the offer group having the curated list of the plurality of offers; and
saving the offer group after performing the operation on the offer group having the curated list of the plurality of offers.
